(19) United States
(12) Patent Application Publication
(10) Pub. No.: US 2024/0086148 A1
(43) Pub. Date: Mar. 14, 2024

(54) SYSTEMS AND METHODS FOR MULTIMODAL ANALYSIS AND RESPONSE GENERATION USING ONE OR MORE CHATBOTS

(71) Applicant: State Farm Mutual Automobile Insurance Company, Bloomington, IL (US)

(72) Inventors: Duane L. Marzinzik, Springfield, IL (US); Matthew Mifflin, Bloomington, IL (US); Christopher Burkiewicz, Bloomington, IL (US)

(21) Appl. No.: 18/502,875

(22) Filed: Nov. 6, 2023

Related U.S. Application Data
(63) Continuation-in-part of application No. 17/095,358, filed on Nov. 11, 2020.
(60) Provisional application No. 62/934,249, filed on Nov. 12, 2019.
(60) Provisional application No. 63/479,723, filed on Jan. 12, 2023.
(60) Provisional application No. 63/387,638, filed on Dec. 15, 2022.

(51) Int. Cl. G06F 3/16; G06F 3/0488; G06Q 40/08

(52) U.S. Cl. CPC G06F 3/167; G06F 3/0488; G06Q 40/08

(57) ABSTRACT

A multi-mode conversational computer system for implementing multiple simultaneous, nearly simultaneous or semi-simultaneous conversations and/or exchanges of information or receipt of user input. The computer system includes: (1) one or more processors and/or transceivers, and one or more memory units; (2) a touch display screen having a graphical user interface configured to accept user touch input; and/or (3) a voice bot configured to accept user voice input. A user engages in at least two separate exchanges of information/data with the computer system simultaneously, nearly simultaneously, or nearly at the same time via the touch display screen and the voice bot.

### CROSS-REFERENCE TO RELATED APPLICATIONS

This application is a continuation in part of and claims priority to U.S. patent application Ser. No. 17/095,358, filed Nov. 11, 2020, entitled “SYSTEMS AND METHODS FOR ANALYZING AND RESPONDING TO SPEECH USING ONE OR MORE CHATBOTS,” which claims priority to U.S. Provisional Patent Application No. 62/934,249, filed Nov. 12, 2019, entitled “SYSTEMS AND METHODS FOR ANALYZING AND RESPONDING TO SPEECH USING ONE OR MORE CHATBOTS,” and the application also claims priority to U.S. Provisional Patent Application No. 63/479,723, filed Jan. 12, 2023, entitled “SYSTEMS AND METHODS FOR MULTIMODAL ANALYSIS AND RESPONSE GENERATION USING ONE OR MORE CHATBOTS,” and to U.S. Provisional Patent Application No. 63/387,638, filed Dec. 15, 2022, entitled “SYSTEMS AND METHODS FOR MULTIMODAL ANALYSIS AND RESPONSE GENERATION USING ONE OR MORE CHATBOTS,” the entire contents and disclosures of which are hereby incorporated herein by reference in their entirety.

### FIELD OF THE INVENTION

The present disclosure relates to analyzing and responding to speech using one or more chatbots, and more particularly, to a network-based system and method for routing utterances received from a user among a plurality of chatbots during a conversation based upon an identified intent associated with the utterance.

### BACKGROUND

Chatbots may be used, for example, to answer questions, obtain information from, and/or process requests from a user. Many of these programs are capable of understanding only simple commands or sentences. During normal speech, users may use run on sentences, colloquialisms, slang terms, and other adjustments to the normal rules of the language the user is speaking, which may be difficult for such chatbots to interpret. On the other hand, sentences that are understandable to such chatbots may be simple to the point of being stilted or awkward for the speaker.

Further, a particular chatbot application is generally only capable of understanding a limited scope of subject matter, and a user generally must manually access the particular chatbot application (e.g., by entering touchtone digits, by selecting from a menu, etc.). The need for such manual input generally reduces the effectiveness of the chatbot in simulating a natural conversation. In addition, a single sentence submitted by a user may include multiple types of subject matter that do not fall within the scope of any one particular chatbot application. Accordingly, a chatbot that can more accurately and efficiently interpret complex statements and/or questions submitted by a user is therefore desirable.

### BRIEF SUMMARY

The present embodiments may relate to, inter alia, systems and methods for parsing separate intents in natural language speech. The system may include a speech analysis (SA) computer system and/or one or more user computer devices. In one aspect, the present embodiments may make a chatbot more conversational than conventional bots. For instance, with the present embodiments, a chatbot is provided that can understand more complex statements and/or a broader scope of subject matter than with conventional techniques.

In one aspect, a speech analysis (SA) computer device may be provided. The SA computing device may include at least one processor in communication with at least one memory device. The SA computer device may be in communication with a user computer device associated with a user. The at least one processor may be configured to: (1) receive, from the user computer device, a verbal statement of a user including a plurality of words; (2) translate the verbal statement into text; (3) detect one or more pauses in the verbal statement; (4) divide the verbal statement into a plurality of utterances based upon the one or more pauses; (5) identify, for each of the plurality of utterances, an intent using an orchestrator model; (6) select, for each of the plurality of utterances, based upon the intent corresponding to the utterance, a bot to analyze the utterance; and/or (7) generate a response by applying the bot selected for each of the plurality of utterances to the corresponding utterance. The SA computing device may include additional, less, or alternate functionality, including that discussed elsewhere herein.

In another aspect, a computer-implemented method may be provided. The computer-implemented method may be performed by a speech analysis (SA) computer device including at least one processor in communication with at least one memory device. The SA computer device may be in communication with a user computer device associated with a user. The method may include: (1) receiving, by the SA computer device, from the user computer device, a verbal statement of a user including a plurality of words; (2) translating, by the SA computer device, the verbal statement into text; (3) detecting, by the SA computer device, one or more pauses in the verbal statement; (4) dividing, by the SA computer device, the verbal statement into a plurality of utterances based upon the one or more pauses; (5) identifying, by the SA computer device, for each of the plurality of utterances, an intent using an orchestrator model; (6) selecting, by the SA computer device, for each of the plurality of utterances, based upon the intent corresponding to the utterance, a bot to analyze the utterance; and/or (7) generating, by the SA computer device, a response by applying the bot selected for each of the plurality of utterances to the corresponding utterance. The computer-implemented method may include additional, less, or alternate actions, including those discussed elsewhere herein.

In another aspect, at least one non-transitory computer-readable media having computer-executable instructions embodied thereon may be provided. When executed by a speech analysis (SA) computing device including at least one processor in communication with at least one memory device and in communication with a user computer device associated with a user, the computer-executable instructions may cause the at least one processor to: (1) receive, from the user computer device, a verbal statement of a user including a plurality of words; (2) translate the verbal statement into text; (3) detect one or more pauses in the verbal statement; (4) divide the verbal statement into a plurality of utterances based upon the one or more pauses; (5) identify, for each of the plurality of utterances, an intent using an orchestrator model; (6) select, for each of the plurality of utterances, based upon the intent corresponding to the utterance, a bot to analyze the utterance; and/or (7) generate a response by applying the bot selected for each of the plurality of utterances to the corresponding utterance. The computer-executable instructions may direct additional, less, or alternate functionality, including that discussed elsewhere herein.

In one aspect, a computer system may be provided. The system may include a multimodal server including at least one processor in communication with at least one memory device. The multimodal server is in communication with a user computer device associated with a user. The system also includes an audio handler including at least one processor in communication with at least one memory device. The audio handler is in communication with the multimodal server. The at least one processor of the audio handler programmed to: (1) receive, from the user computer device via the multimodal server, a verbal statement of a user including a plurality of words; (2) translate the verbal statement into text; (3) select a bot to analyze the verbal statement; (4) generate an audio response by applying the bot selected for the verbal statement; and/or (5) transmit the audio response to the multimodal server. The at least one processor of the multimodal server is programmed to: (1) receive the audio response to the user from the audio handler; (2) enhance the audio response to the user; and/or (3) provide the enhanced response to the user via the user computer device. The system may include additional, less, or alternate functionality, including that discussed elsewhere herein.

In still another aspect, a computer-implemented method may be provided. The computer-implemented method may be performed by a speech analysis (SA) computer device including at least one processor in communication with at least one memory device. The SA computer device may be in communication with a user computer device associated with a user. The method may include: (1) receiving, from the user computer device, a verbal statement of a user including a plurality of words; (2) translating the verbal statement into text; (3) selecting a bot to analyze the verbal statement; (4) generating an audio response by applying the bot selected for the verbal statement; (5) enhancing the audio response to the user; and/or (6) providing the enhanced response to the user via the user computer device. The computer-implemented method may include additional, less, or alternate actions, including those discussed elsewhere herein.

In a further aspect, at least one non-transitory computer-readable media having computer-executable instructions embodied thereon may be provided. When executed by a computing device including at least one processor in communication with at least one memory device and in communication with a user computer device associated with a user, the computer-executable instructions may cause the at least one processor to: (1) receive, from a user computer device, a verbal statement of a user including a plurality of words; (2) translate the verbal statement into text; (3) select a bot to analyze the verbal statement; (4) generate an audio response by applying the bot selected for the verbal statement; (5) enhance the audio response to the user; and/or (6) provide the enhanced response to the user via the user computer device. The computer-executable instructions may direct additional, less, or alternate functionality, including that discussed elsewhere herein.

In at least one aspect, a computer system for analyzing voice bots may be provided. The computer system may include at least one processor and/or transceiver in communication with at least one memory device. The at least one processor and/or transceiver is programmed to: (1) store a plurality of completed conversations, where each conversation of the plurality of completed conversations includes a plurality of interactions between a user and a voice bot; (2) analyze the plurality of completed conversations; (3) determine a score for each completed conversation based upon the analysis, the score indicating a quality metric for the corresponding conversation; and/or (4) generate a report based upon the plurality of scores for the plurality of completed conversations. The computer system may include additional, less, or alternate functionality, including that discussed elsewhere herein.

In another aspect, a computer-implemented method for analyzing voice bots may be provided. The method may be performed by a computer device including at least one processor and/or transceiver in communication with at least one memory device. The method may include: (1) storing a plurality of completed conversations, wherein each conversation of the plurality of completed conversations includes a plurality of interactions between a user and a voice bot; (2) analyzing the plurality of completed conversations; (3) determining a score for each completed conversation based upon the analysis the score indicating a quality metric for the corresponding conversation; and/or (4) generating a report based upon the plurality of scores for the plurality of completed conversations. The computer-implemented method may include additional, less, or alternate actions, including those discussed elsewhere herein.

In a further aspect, at least one non-transitory computer-readable media having computer-executable instructions embodied thereon may be provided. When executed by a computing device including at least one processor in communication with at least one memory device and in communication with a user computer device associated with a user, the computer-executable instructions may cause the at least one processor to: (1) store a plurality of completed conversations, where each conversation of the plurality of completed conversations includes a plurality of interactions between a user and a voice bot; (2) analyze the plurality of completed conversations; (3) determine a score for each completed conversation based upon the analysis, the score indicating a quality metric for the corresponding conversation; and/or (4) generate a report based upon the plurality of scores for the plurality of completed conversations. The computer-executable instructions may direct additional, less, or alternate functionality, including that discussed elsewhere herein.

In at least one aspect, a multi-mode conversational computer system for implementing multiple simultaneous, nearly simultaneous, or semi-simultaneous conversations and/or exchanges of information or receipt of user input may be provided. The computer system may include: (1) at least one processor and/or transceiver in communication with at least one memory device; (2) a voice bot configured to accept user voice input and provide voice output; and/or (3) at least one input and output communication channel configured to accept user input and provide output to the user, wherein the at least one input and output communication channel is configured to communicate with the user via a first channel of the at least one input and output communication channel and the voice bot simultaneously, nearly simultaneously, or nearly at the same time. The computer system may include additional, less, or alternate functionality, including that discussed elsewhere herein.

In another aspect, a computer-implemented method of facilitating a multi-mode conversation via a computer system and/or for implementing multiple simultaneous, nearly simultaneous or semi-simultaneous conversations and/or exchanges of information or receipt of user input via the computer system may be provided. The method may be performed by one or more local or remote processors and/or transceivers, which may be in communication with one or more local or remote memory units and in communication with at least one input and output channel and a voice bot. The method may include: (1) accepting a first user input via the at least one input and output channel; and/or (2) accepting a second user input via the voice bot, wherein the first user input and the second user input are provided via the at least one input and output channel and the voice bot simultaneously, nearly simultaneously, or nearly at the same time. The computer-implemented method may include additional, less, or alternate actions, including those discussed elsewhere herein.

In a further aspect, a computer-implemented method of facilitating a multi-mode conversation via a computer system and/or for implementing multiple simultaneous, nearly simultaneous or semi-simultaneous conversations and/or exchanges of information or receipt of user input via the computer system may be provided. The method may be performed by a computer device including one or more local or remote processors and/or transceivers, and in communication with one or more local or remote memory units and in communication with at least one input and output channel and a voice bot. The method may include: (1) accepting a user input via at least one of the at least one input and output channel and the voice bot; and/or (2) providing an output to the user via at least one of the at least one input and output channel and the voice bot, wherein the user input and the output to the user are provided via at least one of the at least one input and output channel and the voice bot simultaneously, nearly simultaneously, or nearly at the same time. The computer-implemented method may include additional, less, or alternate actions, including those discussed elsewhere herein.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and are instrumentalities shown, wherein:

FIG. 1 illustrates a flow chart of an exemplary process of analyzing and responding to speech using one or more chatbots, in accordance with the present disclosure.

FIG. 2 illustrates a simplified block diagram of an exemplary computer system for implementing the processes shown in FIG. 1.

FIG. 3 illustrates a simplified block diagram of a chat application as shown in FIG. 2, in accordance with the present disclosure.

FIG. 4 illustrates an exemplary configuration of a user computer device, in accordance with one embodiment of the present disclosure.

FIG. 5 illustrates an exemplary configuration of a server computer device, in accordance with one embodiment of the present disclosure.

FIG. 6 illustrates a diagram of exemplary components of analyzing and responding to speech using one or more chatbots, in accordance with one embodiment of the present disclosure.

FIG. 7 illustrates a diagram of an exemplary data flow, in accordance with one embodiment of the present disclosure.

FIG. 8 illustrates an exemplary computer-implemented method for analyzing and responding to speech using one or more chatbots, in accordance with one embodiment of the present disclosure.

FIG. 9 is a continuation of the computer-implemented method illustrated in FIG. 8.

FIG. 10 illustrates an exemplary computer-implemented method for generating a response, in accordance with one embodiment of the present disclosure.

FIG. 11 is a continuation of the computer-implemented method illustrated in FIG. 10.

FIG. 12 is a continuation of the computer-implemented method illustrated in FIG. 10.

FIG. 13 is a continuation of the computer-implemented method illustrated in FIG. 10.

FIG. 14 illustrates an exemplary computer-implemented method for performing multimodal interactions with a user in accordance with at least one embodiment of the disclosure.

FIG. 15 illustrates a simplified block diagram of an exemplary multimodal computer system for implementing the computer-implemented methods shown in FIGS. 14 and 17.

FIG. 16 illustrates a simplified block diagram of an exemplary multimodal computer system for implementing the computer-implemented methods shown in FIGS. 14 and 17.

FIG. 17 illustrates a timing diagram of an exemplary computer-implemented method for performing multimodal interactions with a user shown in FIG. 14 in accordance with at least one embodiment of the disclosure.

FIG. 18 illustrates a simplified block diagram of an exemplary computer system for monitoring logs of the computer networks shown in FIGS. 15 and 16 while implementing the computer-implemented methods shown in FIGS. 14 and 17.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION OF THE DRAWINGS

The present embodiments may relate to, inter alia, systems and methods for parsing multiple intents and, more particularly, to a network-based system and method for parsing the separate intents in natural language speech. In one exemplary embodiment, the process may be performed by a speech analysis (“SA”) computer device. In the exemplary embodiment, the SA computer device may be in communication with a user, such as, through an audio link or text-based chat program, through the user computer device, such as a mobile computer device. In the exemplary embodiment, the SA computer device may be in communication with a user computer device, where the SA computer device transmits data to the user computer device to be displayed to the user and receives the user's inputs from the user computer device.

In the exemplary embodiment, the SA computer device may receive a complete statement from a user. For the purposes of this discussion, the statement may be a complete sentence or a short answer to a query. The SA computer device may label each word of the statement based upon the word type. The statement may include one or more utterances, which may be portions of the statement defined by pauses in speech. The SA computer device may analyze the statement to divide it up into utterances, which then may be analyzed to identify specific phrases within the utterance (sometimes referred to herein as “intents”). An intent may include a single idea (e.g., a data point having a specific meaning), whereas an utterance may include no ideas or any number of ideas. For example, a statement may include multiple intents. The SA computer device or other computer device may then act on or respond to each individual intent.

In the exemplary embodiment, the SA computer device may break up compound and complex statements into smaller utterances to be submitted for intent recognition. For example, the statement: “I want to extend my stay for my room number abc,” may resolve into two utterances. The two utterances are “I want to extend my stay” and “for my room number abc.” These utterances may then be analyzed to determine if they include intents, which may be used by the SA computing device, for example, to generate a response to the statement and/or to prioritize a plurality of utterances included with in the statement.

In the exemplary embodiment, a user may use their user computer device (e.g., a mobile phone or other computing device with telephone call capabilities including voice over internet protocol (VOIP)) to place a phone call. The SA computer device may receive the phone call and interpret the user's speech. In other embodiments, the SA computer device may be in communication with a phone system computer device, where the phone system computer device receives the phone call and transmits the audio to the SA computer device. In the exemplary embodiment, the SA computer device may be in communication with one or more computer devices that are capable of performing actions based upon the user's requests. In one example, the user may be placing a phone call to order a pizza. The additional computer devices may be capable of receiving the pizza order and informing the pizza restaurant of the pizza order.

In the exemplary embodiment, the audio stream may be received by the SA computer device via a websocket. In some embodiments, the websocket may be opened by the phone system computer device. In real-time, the SA computer device may use speech to text natural language processing to interpret the audio stream. In the exemplary embodiment, the SA computer device may interpret the translated text of the speech. When the SA computer device detects a long pause, the SA computer device may determine if the long pause is the end of a statement or the end of the user talking.

If the pause is the end of a statement, the SA computer device may flag (or tag) the text as a statement and may process the statement. The SA computing device may further identify pauses within the statement and identify portions of the statement between the pauses as utterances. The SA computer device may identify the top intent by sending the utterance to an orchestrator model that is capable of identifying the intents of the statement. The SA computer device may extract data (e.g., a meaning of the utterance) from the identified intents using, for example, a specific bot corresponding to the identified intents. The SA computer device may store all of the information about the identified intents in a session database, which may include a specific data structure (sometimes referred to herein as a “session”) that may be configured to store data for the processing of a specific statement.

If the pause is the end of the user's talking, the SA computer device may process the user's statements (also known as the user's turn). The SA computer device may retrieve the session from the session database. The SA computer device may sort and prioritize all of the intents based upon stored business logic and pre-requisites. The SA computer device may process all of the intents in proper order and determine if there are any missing data points necessary to process the user's turn. In some embodiments, the SA computer device may use a bot fulfillment module to request the missing entities from the user. The SA computer device may update the sessions in the session database. The SA computer device may determine a response to the user based upon the statements made by the user. In some embodiments, the SA computer device may convert the text of the response back into speech before transmitting to the user, such as via the audio stream. In other embodiments, the SA computer device may display text or images to the user in response to the user's speech.

While the above describes the audio translation of speech, the systems described herein may also be used for interpreting text-based communication with a user, such as through a text-based chat program. In some embodiments, the orchestrator model or orchestrator may be viewed as a conversation “traffic cop,” and during a conversation with a user, continuously direct small portions of the entire conversation to dedicated and/or different bots for handing.

For instance, individual bots could be dedicated to gathering user information, gathering address information, gathering or providing insurance claim information, providing insurance policy information, gathering images of vehicles, homes, or damaged assets, etc. Once the orchestrator recognizes that a user is referring to “vehicle rental coverage,” it may immediately direct the conversation to a rental coverage bot for handling that portion of the conversation with the user that is directed to vehicle rental coverage. Or if the orchestrator recognizes that the current portion of the conversation with the user is related to a user question about an insurance claim number, it may direct the current portion of the conversation with the user to a claim number bot for handling.

In further enhancements, the SA computer device may also be in communication with a multimodal system that may be used to combine the audio processing of the bots with visual and/or text-based communication with the users. Multimodal interactions may include at least one additional channel of communication in addition to audio. For example, visual and/or text communication may be used to supplement and/or enhance the audio communication. In one example, a text statement of the user and/or caller may be added to a display screen to show the user how their words are being understood. Furthermore, a text statement may accompany an audio message from the bots to provide captions for the audio message. This extra communication could also be used for validation purposes.

In these embodiments, the SA computer device and/or an audio handler may receive audio information from a plurality of channels including pure audio channels, such as phone calls, and multimodal channels, such as via apps. The SA computer device and/or the audio handler uses the bots to determine responses to the audio information and returns audio responses to the corresponding source channel. If a phone channel, then the phone will play the audio response to the caller. If a multimodal channel, the associated user computer device may be instructed to play the audio response and display a text version of the response. The multimodal channel may also add additional information or replace some information based upon the audio response to enhance or improve the user's experience.

Furthermore, in some embodiments, the components of the system, such as the SA computer device, the audio handler, and/or the multimodal server, may report actions that have occurred during a call and/or conversation to logs. An analysis system may analyze the logs for errors and/or other issues that may have occurred on one or more calls/conversations. For example, the report logs may include the time of incoming calls, what the calls related to, how the calls were addressed or directed, etc. The errors may include whether the bots correctly interpreted the purpose of the incoming call, correctly directed the call to the proper location, provided the proper response and/or resolved the caller's issue or request. The analysis may be of individual calls, of all calls within a specific period, and/or for a large number of calls. The analysis may be used to improve the performs of the bot system described herein.

At least one of the technical problems addressed by this system may include: (i) unsatisfactory user experience when interacting with a chatbot application; (ii) inability of a computing device to automatically select a chatbot to process a statement of a user based upon the contents of the statement; (iii) inability of a computing device executing a chatbot application to simultaneously prioritize and process a plurality of utterances included within a user's statement; (iv) inefficiency of computing devices executing a chatbot application in processing statements that contain a plurality of utterances having a plurality of intents; (v) inefficiency in parsing and routing data received from a user via a chatbot application; (vi) inefficiency in retrieving data requested by a user via a chatbot application; (vii) adding additional information to a response by providing a text or visual response in addition to a verbal response; (viii) efficiently tracking performance of the system; (xi) detecting trends and issues quickly and efficiently; (x) providing the user with additional methods of providing information; and/or (xi) efficiency in generating speech responses to statements submitted by a user via a chatbot application.

A technical effect of the systems and processes described herein may be achieved by performing at least one of the following steps: (i) receiving, from the user computer device, a verbal statement of a user including a plurality of words; (ii) translating the verbal statement into text; (iii) detecting one or more pauses in the verbal statement; (iv) dividing the verbal statement into a plurality of utterances based upon the one or more pauses; (v) identifying, for each of the plurality of utterances, an intent using an orchestrator model; (vi) selecting, for each of the plurality of utterances, based upon the intent corresponding to the utterance, a bot to analyze the utterance; and/or (vii) generating a response by applying the bot selected for each of the plurality of utterances to the corresponding utterance.

The technical effect achieved by this system may be at least one of: (i) improved user experience when interacting with a chatbot application; (ii) ability of a computing device to automatically select a chatbot to process a statement of a user based upon the contents of the statement; (iii) ability of a computing device executing a chatbot application to simultaneously prioritize and process a plurality of utterances included within a user's statement; (iv) increased efficiency of computing devices executing a chatbot application in processing statements that contain a plurality of utterances having a plurality of intents; (v) increased efficiency in parsing and routing data received from a user via a chatbot application; (vi) increased efficiency in retrieving data requested by a user via a chatbot application; and/or (vii) increased efficiency in generating speech responses to statements submitted by a user via a chatbot application.

### Exemplary Process for Parsing Intents in a Conversation

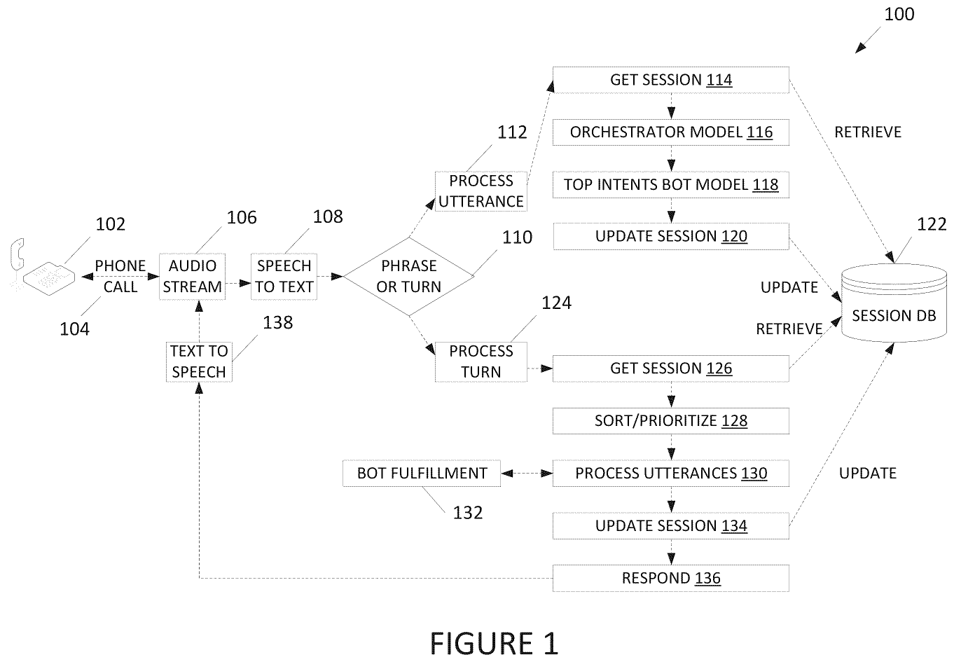

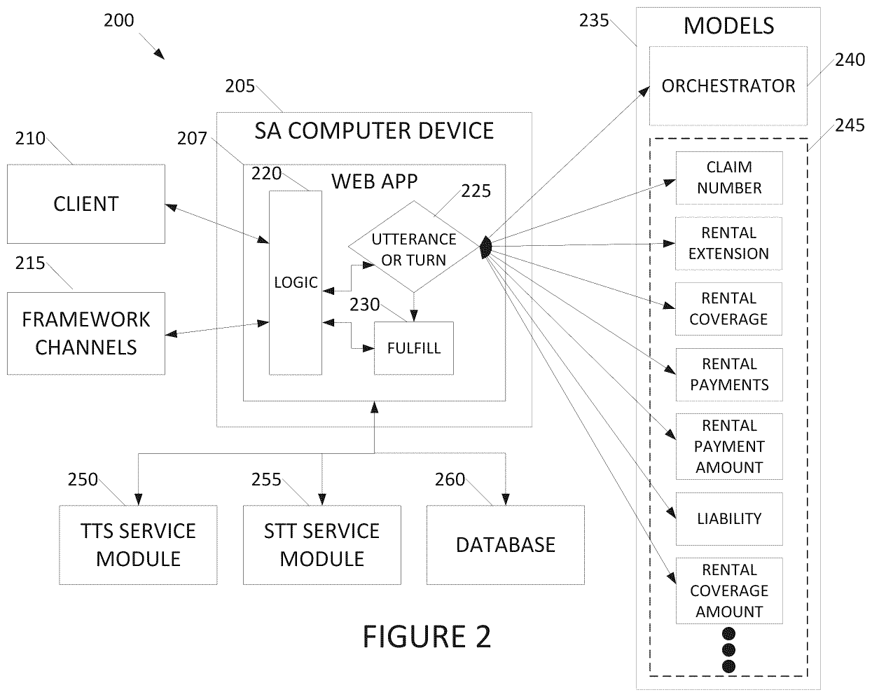

FIG. 1 illustrates a flow chart of an exemplary process 100 of analyzing and responding to speech using one or more chatbots, in accordance with the present disclosure. In the exemplary embodiment, process 100 is performed by a computer device, such as speech analysis (“SA”) computer device 205 (shown in FIG. 2). In the exemplary embodiment, SA computer device 205 may be in communication with a user computer device 102, such as a mobile computer device. In this embodiment, SA computer device 205 may perform process 100 by transmitting data to the user computer device 102 to be displayed to the user and receives the user's inputs from user computer device 210.

In the exemplary embodiment, a user may use their user computer device 102 to place a phone call 104. SA computer device 205 may receive the phone call 104 and interpret the user's speech. In other embodiments, the SA computer device 205 may be in communication with a phone system computer device, where the phone system computer device receives the phone call 104 and transmits the audio to SA computer device 205. In the exemplary embodiment, the SA computer device 205 may be in communication with one or more computer devices that are capable of performing actions based upon the user's requests. In one example, the user may be placing a phone call 104 to order a pizza. The additional computer devices may be capable of receiving the pizza order, and informing the pizza restaurant of the pizza order.

In the exemplary embodiment, the audio stream 106 may be received by the SA computer device 205 via a websocket. In some embodiments, the websocket is opened by the phone system computer device. In real-time, the SA computer device 205 may use speech to text natural language processing 108 to interpret the audio stream 106. In the exemplary embodiment, the SA computer device 205 may interpret the translated text of the speech. When the SA computer device 205 detects a long pause, the SA computer device 205 may determine 110 if the long pause is the end of a statement or the end of the user talking. For the purposes of this discussion, the statement may be a complete sentence or a short answer to a query.

If the pause is the end of a statement, the SA computer device 205 may flag (or tag) the text as a statement and processes 112 the statement. The SA computer device 205 may analyze the statement to divide it up into utterances, which then may be analyzed to identify specific phrases within the utterance (e.g., intents). An intent may include a single idea (e.g., a data point having a specific meaning), whereas an utterance may include no ideas or any number of ideas. For example, a statement may include multiple intents. The SA computer device 205 may generate a session 114 including the resulting utterances in session database 122. The SA computer device 205 may identify the top intent by sending the utterance to an orchestrator model 116 that is capable of identifying the intents of a statement. The SA computer device 205 may extract data 118 from the identified intents using, for example, a specific bot corresponding to the identified intents. The SA computer device 205 may store 120 all of the information about the identified intents in the session database 122.

If the pause is the end of the user's talking, the SA computer device 205 may process 124 the user's statements (also known as the user's turn). The SA computer device 205 may retrieve 126 the session from the session database 122. The SA computer device 205 may sort and prioritize 128 all of the intents based upon stored business logic and pre-requisites. The SA computer device 205 may process 130 all of the intents in proper order and determines if there are any missing entities. In some embodiments, the SA computer device 205 may use a bot fulfillment module 132 to request the missing entities from the user. The SA computer device 205 may update 134 the sessions in the session database 122. The SA computer device 205 may determine 136 a response to the user based upon the statements made by the user. In some embodiments, the SA computer device 205 may convert 138 the text of the response back into speech before transmitting to the user, such as via the audio stream 106. In other embodiments, the SA computer device 205 may display text or images to the user in response to the user's speech.

In the exemplary embodiment, process 100 may breakup compound and complex statements into smaller utterances to be submitted for intent recognition. For example, the statement: “I want to extend my stay for my room number abc,” would resolve into two utterances. The two utterances are “I want to extend my stay” and “for my room number abc.” These utterances are then analyzed to determine if they include intents, which may be used by the SA computing device, for example, to generate a response to the statement and/or to prioritize a plurality of utterances included with in the statement.

While the above describes the audio translation of speech, the systems described herein may also be used for interpreting text-based communication with a user, such as through a text-based chat program.

### Exemplary Computer Network

FIG. 2 illustrates a simplified block diagram of an exemplary computer system 200 for implementing the processes 100 shown in FIG. 1. In the exemplary embodiment, computer system 200 may be used for parsing intents in a conversation.

In the exemplary embodiment, the computer system 200 may include a speech analysis (“SA”) computer device 205. In the exemplary embodiment, SA computer device 205 may execute a web app 207 or ‘bot’ for analyzing speech. In some embodiments, the web app 207 may include an orchestration layer, an on turn context module, a dialog fulfillment module, and a session management module. In some embodiments, process 100 may be executed using the web app 207. In the exemplary embodiment, the SA computer device 205 may be in communication with a user computer device 210, where the SA computer device 205 is capable of receiving audio from and transmitting either audio or text to the user computer device 210. In other embodiments, the SA computer device 205 may be capable of communicating with the user via one or more framework channels 215. These framework channels 215 may include, but are not limited to, direct lines or voice chat via a program such as Skype, text chats, SMS messages, or other connections.

In the exemplary embodiment, the SA computer device 205 may receive conversation data, such as audio, from the user computer device 210, the framework channels 215, or a combination of the two. The SA computer device 205 may use internal logic 220 to analyze the conversation data. The SA computer device 205 may determine 225 whether the pauses in the conversation data represents the end of a statement or a user's turn of talking. The SA computer device 205 may fulfill 230 the request from the user based upon the analyzed and interpreted conversation data.

In some embodiments, the SA computer device 205 may be in communication with a plurality of models 235 for analysis. The models 235 may include an orchestrator 240 for analyzing the different intents and then parsing the intents into data 245. In insurance embodiments, the orchestrator 240 may parse the received intents into different categories of data 245. In this example, the orchestrator 240 may recognize categories of data 245 including: claim number, rental extension, rental coverage, rental payments, rental payment amount, liability, and rental coverage amount. In some embodiments, each of the categories of data 245 may have a dedicated chat bot, and the orchestrator 240 may assign one of the dedicated chat bots to analyze, and respond to, the conversation data, or a portion of the conversation data.

In some embodiments, the SA computer device 205 may be in communication with a text to speech (TTS) service module 250 and a speech to text (STT) service module 255. In some embodiments, the SA computer device 205 may use these service modules 250 and 255 to perform the translation between speech and text.

In the exemplary embodiment, user computer devices 210 may include computers that include a web browser or a software application, which enables user computer devices 210 to access remote computer devices, such as SA computer device 205, using the Internet, phone network, or other network. More specifically, user computer devices 210 may be communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem.

User computer devices 210 may be any device capable of accessing the Internet including, but not limited to, a desktop computer, a laptop computer, a personal digital assistant (PDA), a cellular phone, a smartphone, a tablet, a phablet, wearable electronics, smart watch, or other web-based connectable equipment or mobile devices. In some embodiments, user computer device 210 may be in communication with a microphone. In some of these embodiments, the microphone is integrated into user computer device 210. In other embodiments, the microphone may be a separate device that is in communication with user computer device 210, such as through a wired connection (e.g., a universal serial bus (USB) connection).

In some embodiments, the SA computer device 205 may be also in communication with one or more databases 260. In some embodiments, database 260 may be similar to session database 122 (shown in FIG. 1). A database server (not shown) may be communicatively coupled to database 260. In one embodiment, database 260 may include parsed data 245, internal logic 220 for parsing intents, conversation information, or other information as needed to perform the operations described herein. In the exemplary embodiment, database 260 may be stored remotely from SA computer device 205. In some embodiments, database 260 may be decentralized. In the exemplary embodiment, the user may access database 260 via user computer device 210 by logging onto SA computer device 205, as described herein.

SA computer device 205 may be communicatively coupled with one or more user computer devices 210. In some embodiments, SA computer device 205 may be associated with, or is part of a computer network associated with an insurance provider. In other embodiments, SA computer device 205 may be associated with a third party and is merely in communication with the insurer network computer devices. More specifically, SA computer device 205 may be communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem.

SA computer device 205 may be any device capable of accessing the Internet including, but not limited to, a desktop computer, a laptop computer, a personal digital assistant (PDA), a cellular phone, a smartphone, a tablet, a phablet, wearable electronics, smart watch, or other web-based connectable equipment or mobile devices. In the exemplary embodiment, SA computer device 205 may host an application or website that allows the user to access the functionality described herein. In some further embodiments, user computer device 210 may include an application that facilitates communication with SA computer device 205.

### Exemplary Application Architecture

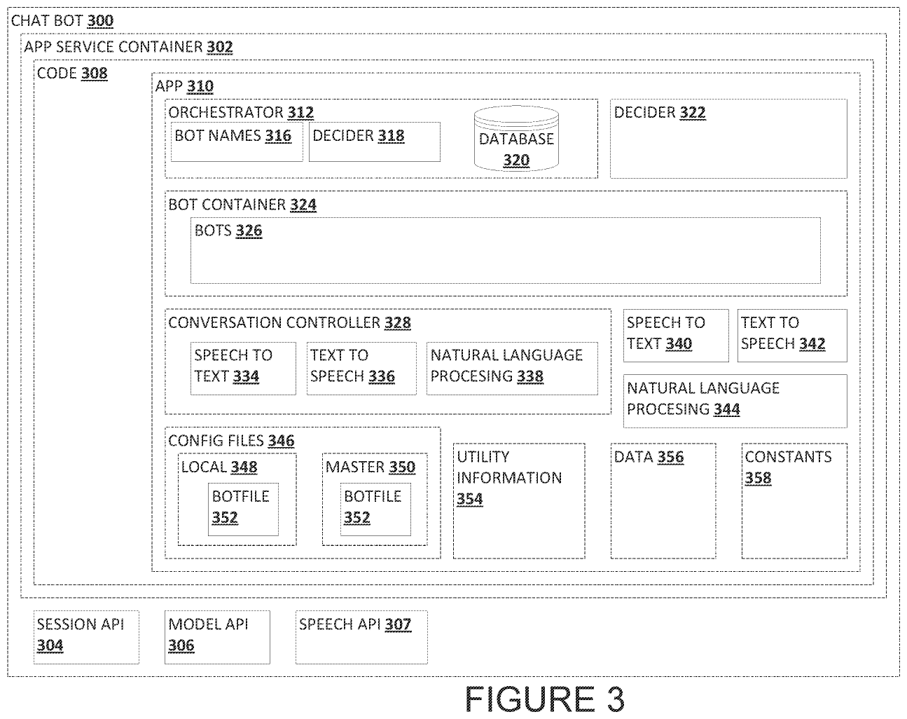

FIG. 3 illustrates a simplified block diagram of a chat application 300 as shown in FIG. 2, in accordance with the present disclosure. In the exemplary embodiment, chat application 300 (also known as chatbot) is executed on SA computer device 205 (shown in FIG. 2) and is similar to web app 207.

In the exemplary embodiment, the chat application 300 may execute a container 302 such as an “app service.” The chat application 300 may include application programming interfaces (APIs) for communication with various systems, such as, but not limited to, a Session API 304, a model API 306 for communicating with the models 235 (shown in FIG. 2), and a speech API 307.

The container may include the code 308 and the executing app 310. The executing app 310 may include an orchestrator 312 which may orchestrate communications with the framework channels 215 (shown in FIG. 2). An instance 314 of the orchestrator 312 may be contained in the code 308. The orchestrator 312 may include multiple instances of bot names 316, which may correspond to bots 326. The orchestrator 312 may also include a decider instance 318 of decider 322. The decider 322 may contain the logic for routing information and controlling bots 326. The orchestrator 312 also may include access to one or more databases 320, which may be similar to session database 122 (shown in FIG. 1). The executing app 310 may include a bot container 324 which includes a plurality of different bots 326, each of which has its own functionality. In some embodiments, the bots 326 are each programmed to handle a different type of data 245 (shown in FIG. 2).

The executing app 310 may also contain a conversation controller 328 for controlling the communication between the customer/user and the applications using the data 245. An instance 330 of the conversation controller 328 may be stored in the code 308. The conversation controller 328 may control instances of components 332. For example, there may be an instance 334 of a speech to text component 340, an instance 336 of a text to speech component 342, and an instance 338 of a natural language processing component 344.

The executing application may also include config files 346. These may include local 348 and master 350 botfiles 352. The executing app 310 may further include utility information 354, data 356, and constants 358 to execute its functionality.

The above description is a simplified description of a chat application 300 that may be used with the systems and methods described herein. However, the chat application 300 may include less or more functionality as needed.

### Exemplary Client Device

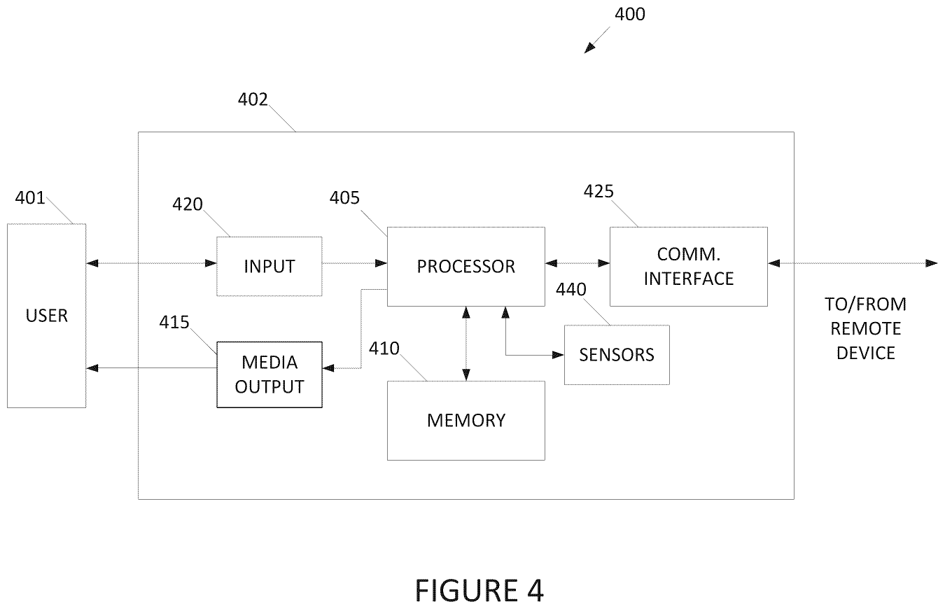

FIG. 4 depicts an exemplary configuration 400 of user computer device 402, in accordance with one embodiment of the present disclosure. In the exemplary embodiment, user computer device 402 may be similar to, or the same as, user computer device 102 (shown in FIG. 1) and user computer device 210 (shown in FIG. 2). User computer device 402 may be operated by a user 401. User computer device 402 may include, but is not limited to, user computer devices 102, user computer device 210, and SA computer device 205 (shown in FIG. 2).

User computer device 402 may include a processor 405 for executing instructions. In some embodiments, executable instructions may be stored in a memory area 410. Processor 405 may include one or more processing units (e.g., in a multi-core configuration). Memory area 410 may be any device allowing information such as executable instructions and/or transaction data to be stored and retrieved. Memory area 410 may include one or more computer readable media.

User computer device 402 may also include at least one media output component 415 for presenting information to user 401. Media output component 415 may be any component capable of conveying information to user 401. In some embodiments, media output component 415 may include an output adapter (not shown) such as a video adapter and/or an audio adapter. An output adapter may be operatively coupled to processor 405 and operatively couplable to an output device such as a display device (e.g., a cathode ray tube (CRT), liquid crystal display (LCD), light emitting diode (LED) display, or “electronic ink” display) or an audio output device (e.g., a speaker or headphones).

In some embodiments, media output component 415 may be configured to present a graphical user interface (e.g., a web browser and/or a client application) to user 401. A graphical user interface may include, for example, an interface for viewing instructions or user prompts. In some embodiments, user computer device 402 may include an input device 420 for receiving input from user 401. User 401 may use input device 420 to, without limitation, provide information either through speech or typing.

Input device 420 may include, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen may function as both an output device of media output component 415 and input device 420.

User computer device 402 may also include a communication interface 425, communicatively coupled to a remote device such as SA computer device 205 (shown in FIG. 2). Communication interface 425 may include, for example, a wired or wireless network adapter and/or a wireless data transceiver for use with a mobile telecommunications network.

Stored in memory area 410 are, for example, computer readable instructions for providing a user interface to user 401 via media output component 415 and, optionally, receiving and processing input from input device 420. A user interface may include, among other possibilities, a web browser and/or a client application. Web browsers enable users, such as user 401, to display and interact with media and other information typically embedded on a web page or a website from SA computer device 205. A client application may allow user 401 to interact with, for example, SA computer device 205. For example, instructions may be stored by a cloud service, and the output of the execution of the instructions sent to the media output component 415.

### Exemplary Server Device

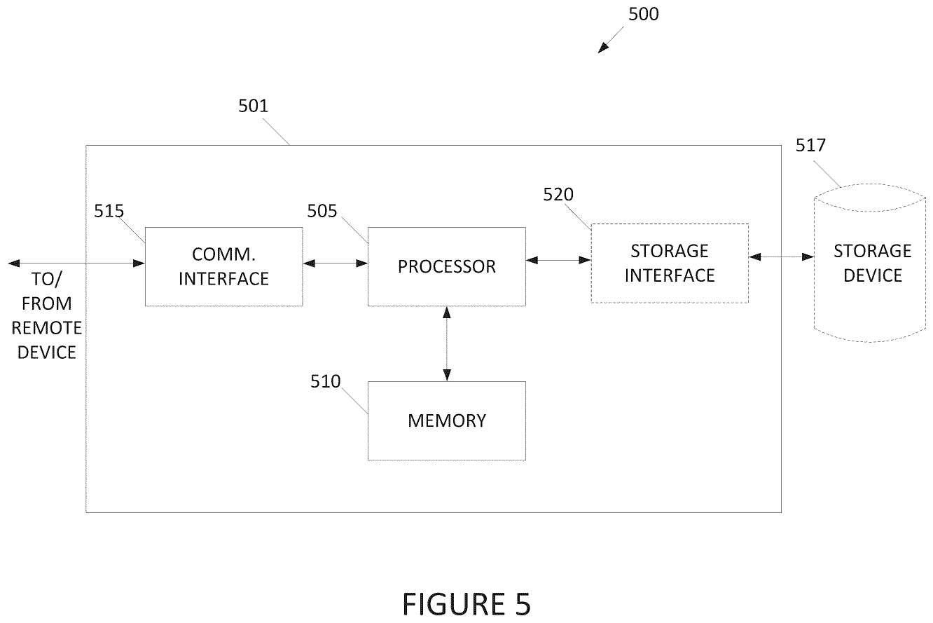

FIG. 5 depicts an exemplary configuration 500 of a server computer device 501, in accordance with one embodiment of the present disclosure. In the exemplary embodiment, server computer device 501 may be similar to, or the same as, SA computer device 205 (shown in FIG. 2). Server computer device 501 may also include a processor 505 for executing instructions. Instructions may be stored in a memory area 510. Processor 505 may include one or more processing units (e.g., in a multi-core configuration).

Processor 505 may be operatively coupled to a communication interface 515 such that server computer device 501 is capable of communicating with a remote device such as another server computer device 501, SA computer device 205, and user computer devices 210 (shown in FIG. 2) (for example, using wireless communication or data transmission over one or more radio links or digital communication channels). For example, communication interface 515 may receive requests from user computer devices 210 via the Internet, as illustrated in FIG. 3.

Processor 505 may also be operatively coupled to a storage device 534. Storage device 534 may be any computer-operated hardware suitable for storing and/or retrieving data, such as, but not limited to, data associated with session database 122 (shown in FIG. 1) and database 320 (shown in FIG. 3). In some embodiments, storage device 534 may be integrated in server computer device 501. For example, server computer device 501 may include one or more hard disk drives as storage device 534.

In other embodiments, storage device 534 may be external to server computer device 501 and may be accessed by a plurality of server computer devices 501. For example, storage device 534 may include a storage area network (SAN), a network attached storage (NAS) system, and/or multiple storage units such as hard disks and/or solid state disks in a redundant array of inexpensive disks (RAID) configuration.

In some embodiments, processor 505 may be operatively coupled to storage device 534 via a storage interface 520. Storage interface 520 may be any component capable of providing processor 505 with access to storage device 534. Storage interface 520 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 505 with access to storage device 534.

Processor 505 may execute computer-executable instructions for implementing aspects of the disclosure. In some embodiments, the processor 505 may be transformed into a special purpose microprocessor by executing computer-executable instructions or by otherwise being programmed. For example, the processor 505 may be programmed with the instruction such as illustrated in FIG. 1.

### Exemplary Computer Device

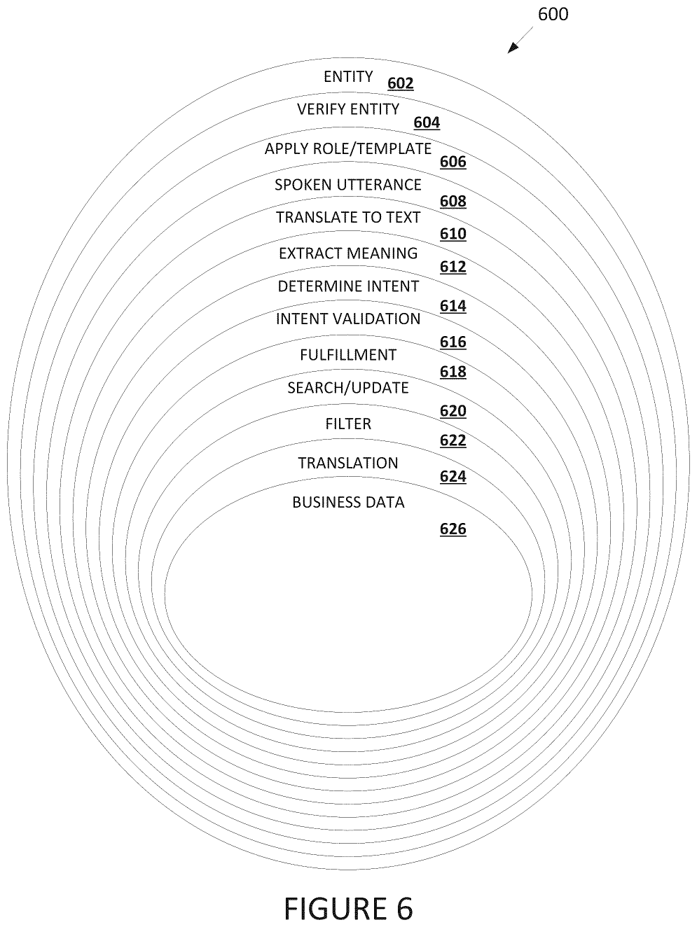

FIG. 6 illustrates a diagram of layers of activities 600 for parsing intents in a conversation in accordance with the process 100 (shown in FIG. 1) using computer system 200 (shown in FIG. 2). In the exemplary embodiment, an entity 602, such as a customer, agent, or vendor, may initiate communication. The computer system 200 may verify 604 the identity of the entity 602. The computer system 200 may apply 606 a role or template to the entity 602. This role may include, but is not limited to, named insured, claimant, a rental vendor, etc. The computer system 200 may receive a spoken statement from the entity 602 which is broken down into one or more spoken utterances 608. The computer system 200 may translate 610 the spoken utterance 608 into text. The computer system 200 may then extract 612 meaning from the translated utterance 608. This meaning may include, but is not limited to, whether the utterance 608 is a question, command, or data point.

The computer system 200 may determine 614 the intents contained within the utterance 608. The computer system 200 then may validate 616 the intent and determine if it fulfills the computer system 200 or if feedback from the entity 602 is required. If the computer system 200 is fulfilled 618, then the data may be searched and updated, such as in the session database 122 (shown in FIG. 1). The data may be then filtered 622 and the translated data 624 may be stored as business data 626.

### Exemplary Data Flow

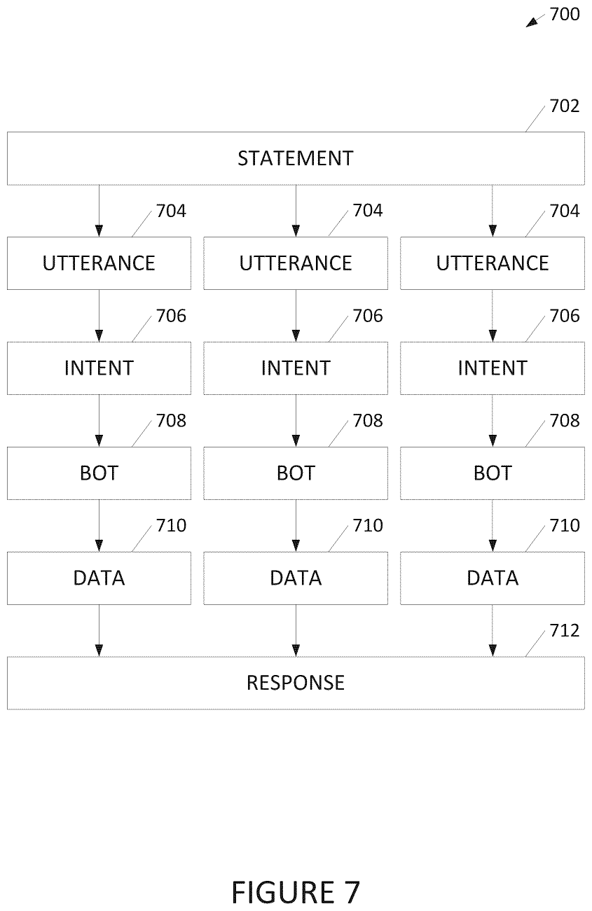

FIG. 7 illustrates a diagram 700 illustrating a flow of data in accordance with the process 100 (shown in FIG. 1) using computer system 200 (shown in FIG. 2). In the exemplary embodiment a statement 702 is received, for example, at SA computing device 205 (shown in FIG. 2). SA computing device 205 may divide the verbal statement into a plurality of utterances 704 based upon an identification of one or more pauses in statement 702. SA computing device 205 may identify an intent 706 for each of the plurality of utterances 704. In some embodiments, SA computing device 205 may identify intent 706 using, for example, orchestrator model 240 (shown in FIG. 2). SA computing device 205 may select a bot 708 (e.g., a model 235 shown in FIG. 2) based upon each intent 706 to extract data 710 (e.g., a meaning of the utterance and/or a data point included in the utterance) from the plurality of utterances 704. SA computing device 205 may generate a response 712 (e.g., a reply to the statement or a request for more information) based upon the extracted data 710. As described herein, a bot may be a software application programmed to analyze messages related to a specific category of data 245 (shown in FIG. 2). More specifically, bots are programmed to analyze for a specific intent 706 to retrieve the data 710 from the utterance 704 related to that intent 706 and to generate a response 712 based upon the extracted data 710. In some embodiments, the data 710 that the bot 708 retrieves is similar to data 245 (shown in FIG. 2).

### Exemplary Method for Analyzing and Responding to Speech Using One or More Chatbots

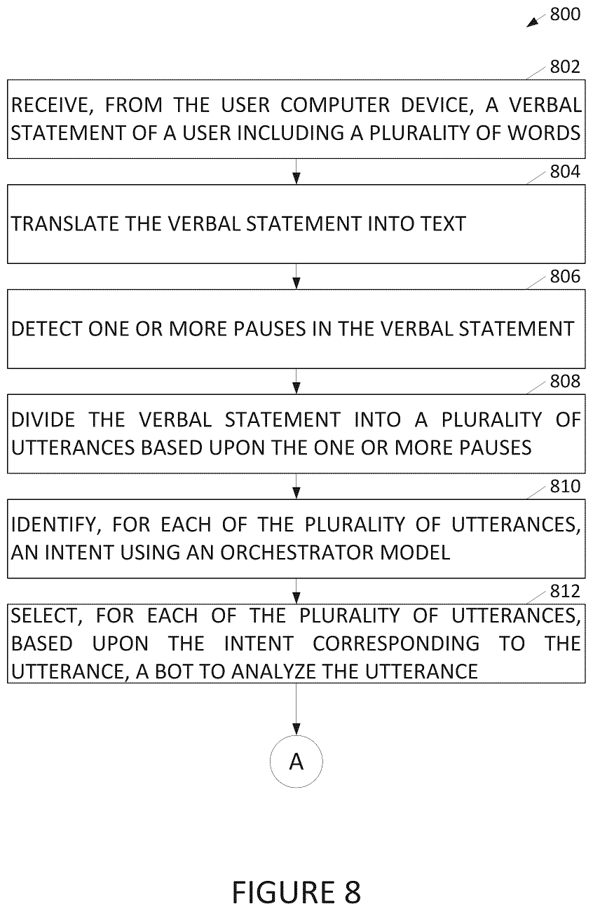

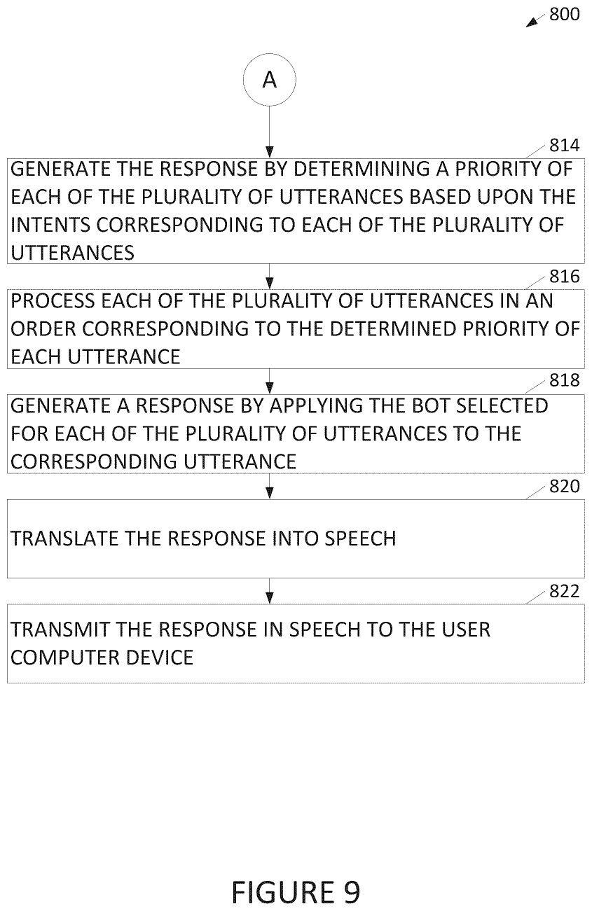

FIGS. 8 and 9 illustrate an exemplary computer-implemented method 800 for analyzing and responding to speech using one or more chatbots that may be implemented using one or more components of computer system 200 (shown in FIG. 2).

Computer-implemented method 800 may include receiving 802, from the user computer device, a verbal statement of a user including a plurality of words. In some embodiments, receiving 802 the verbal statement of the user may be performed by SA computer device 205, for example, by executing framework channels 215. In some embodiments, the verbal statement is received via at least one of a phone call, a chat program, and a video chat.

Computer-implemented method 800 may further include translating 804 the verbal statement into text. In some embodiments, translating 804 the verbal statement may be performed by SA computer device 205, for example, by executing speech to text service module 255.

Computer-implemented method 800 may further include detecting 806 one or more pauses in the verbal statement. In some embodiments, detecting 806 one or more pauses may be performed by SA computer device 205, for example, by executing internal logic 220.

Computer-implemented method 800 may further include dividing 808 the verbal statement into a plurality of utterances based upon the one or more pauses. In some embodiments, dividing 808 the verbal statement may be performed by SA computer device 205, for example, by executing internal logic 220.

Computer-implemented method 800 may further include identifying 810, for each of the plurality of utterances, an intent using an orchestrator model. In some embodiments, identifying 810 the intent may be performed by SA computer device 205, for example, by executing orchestrator 240.

Computer-implemented method 800 may further include selecting 812, for each of the plurality of utterances, based upon the intent corresponding to the utterance, a bot to analyze the utterance. In some embodiments, selecting 812 a bot may be performed by SA computer device 205, for example, by executing orchestrator 240.

In some embodiments, computer-implemented method 800 may further include generating 814 the response by determining a priority of each of the plurality of utterances based upon the intents corresponding to each of the plurality of utterances. In some such embodiments, generating 814 the response may be performed by SA computer device 205, for example, by executing orchestrator 240.

In such embodiments, computer-implemented method 800 may further include processing 816 each of the plurality of utterances in an order corresponding to the determined priority of each utterance. In some such embodiments, processing 816 each of the plurality of utterances may be performed by SA computer device 205, for example, by executing a model 235 corresponding to a category of data 245 associated with each utterance.

Computer-implemented method 800 may further include generating 818 a response by applying the bot selected for each of the plurality of utterances to the corresponding utterance. In some embodiments, generating 818 the response may be performed by SA computer device 205, for example, by executing a model 235 corresponding to a category of data 245 associated with each utterance.

In some embodiments, computer-implemented method 800 may further include translating 820 the response into speech. In some such embodiments, translating 820 the response may be performed by SA computer device 205, for example, by executing text to speech service module 250

In such embodiments, computer-implemented method 800 may further include transmitting 822 the response in speech to the user computer device. In some such embodiments, transmitting 822 the response may be performed by SA computer device 205, for example, by executing framework channels 215.

### Exemplary Method for Generating a Response

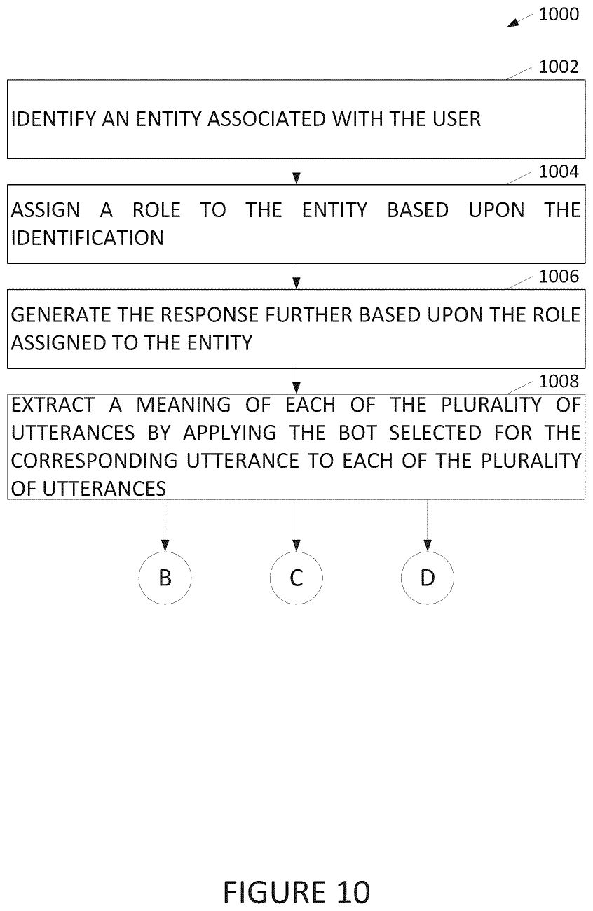

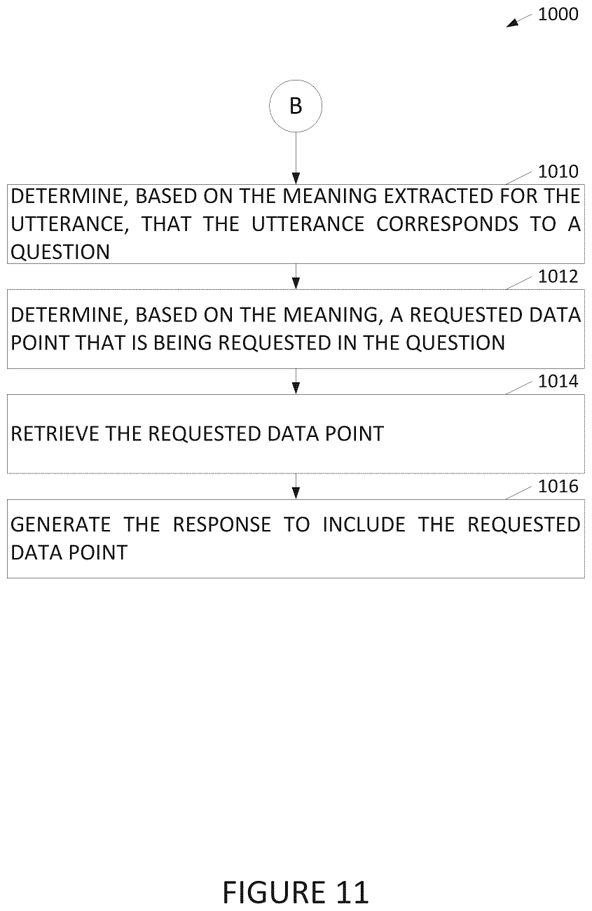

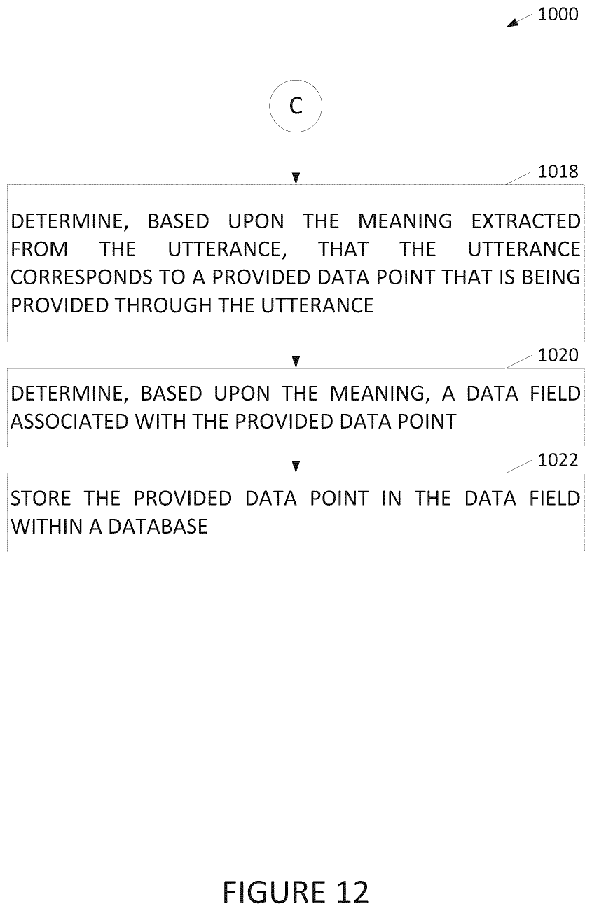

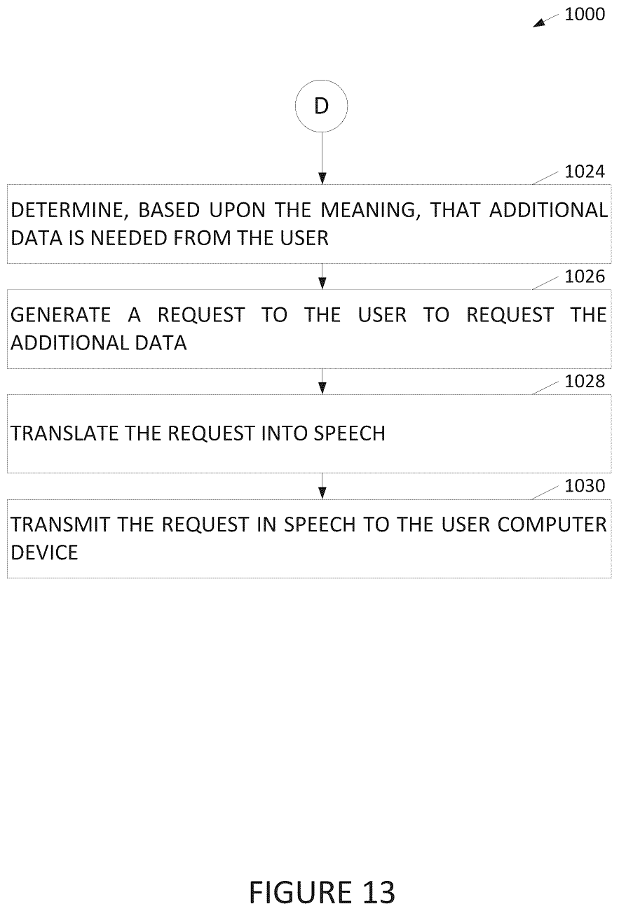

FIGS. 10-13 illustrate an exemplary computer-implemented method 1000 for generating a response that may be implemented using one or more components of computer system 200 (shown in FIG. 2).

In some embodiments, computer-implemented method 1000 may include identifying 1002 an entity associated with the user. In some such embodiments, identifying 1002 and entity associated with the user may be performed by SA computer device 205, for example, by executing orchestrator 240.

In such embodiments, computer-implemented method 1000 may further include assigning 1004 a role to the entity based upon the identification. In some such embodiments, assigning 1004 a role may be performed by SA computer device 205, for example, by executing orchestrator 240.

In such embodiments, computer-implemented method 1000 may further include generating 1006 the response further based upon the role assigned to the entity. In some such embodiments, generating 1006 the response may be performed by SA computer device 205, for example, by executing a model 235 corresponding to a category of data 245 associated with each utterance.

In some embodiments, computer-implemented method 1000 may further include extracting 1008 a meaning of each of the plurality of utterances by applying the bot selected for the corresponding utterance to each of the plurality of utterances. In some such embodiments, extracting 1008 the meaning may be performed by SA computer device 205, for example, by executing a model 235 corresponding to a category of data 245 associated with each utterance.

In such embodiments, computer-implemented method 1000 may further include determining 1010, based upon the meaning extracted for the utterance, that the utterance corresponds to a question. In some such embodiments, determining 1010 that the utterance corresponds to a question may be performed by SA computer device 205, for example, by executing a model 235 corresponding to a category of data 245 associated with each utterance.

In such embodiments, computer-implemented method 1000 may further include determining 1012, based upon the meaning, a requested data point that is being requested in the question. In some such embodiments, determining 1012 the requested data point may be performed by SA computer device 205, for example, by executing a model 235 corresponding to a category of data 245 associated with each utterance.

In such embodiments, computer-implemented method 1000 may further include retrieving 1014 the requested data point. In some such embodiments, retrieving 1014 the requested data point may be performed by SA computer device 205, for example, by executing a model 235 corresponding to a category of data 245 associated with each utterance.

In such embodiments, computer-implemented method 1000 may further include generating 1016 the response to include the requested data point. In some such embodiments, generating 1016 the response may be performed by SA computer device 205, for example, by executing a model 235 corresponding to a category of data 245 associated with each utterance.

In such embodiments, computer-implemented method 1000 may further include determining 1018, based upon the meaning extracted from the utterance, that the utterance corresponds to a provided data point that is being provided through the utterance. In some such embodiments, determining 1018 that the utterance corresponds to a provided data point may be performed by SA computer device 205, for example, by executing a model 235 corresponding to a category of data 245 associated with each utterance.

In such embodiments, computer-implemented method 1000 may further include determining 1020, based upon the meaning, a data field associated with the provided data point. In some such embodiments, determining 1020 the data field may be performed by SA computer device 205, for example, by executing a model 235 corresponding to a category of data 245 associated with each utterance.

In such embodiments, computer-implemented method 1000 may further include storing 1022 the provided data point in the data field within a database. In some such embodiments, storing 1022 the provided data point may be performed by SA computer device 205, for example, by executing a model 235 corresponding to a category of data 245 associated with each utterance.

In such embodiments, computer-implemented method 1000 may further include determining 1024, based upon the meaning, that additional data is needed from the user. In some such embodiments, determining 1024 that additional data is needed may be performed by SA computer device 205, for example, by executing a model 235 corresponding to a category of data 245 associated with each utterance.

In such embodiments, computer-implemented method 1000 may further include generating 1026 a request to the user to request the additional data. In some such embodiments, generating 1026 the request may be performed by SA computer device 205, for example, by executing a model 235 corresponding to a category of data 245 associated with each utterance.

In such embodiments, computer-implemented method 1000 may further include translating 1028 the request into speech. In some such embodiments, translating 1028 the request may be performed by SA computer device 205, for example, by executing text to speech service module 250.

In such embodiments, computer-implemented method 1000 may further include transmitting 1030 the request in speech to the user computer device. In some such embodiments, transmitting 1030 the request may be performed by SA computer device 205, for example, by executing framework channels 215.

Exemplary Method for Multimodal Interactions with a User

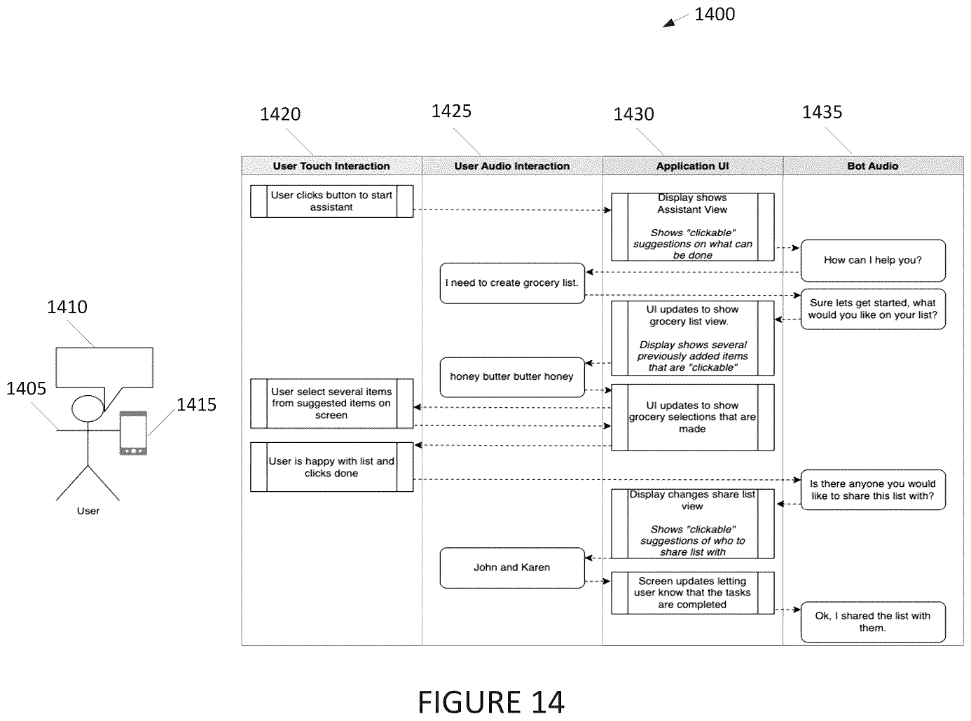

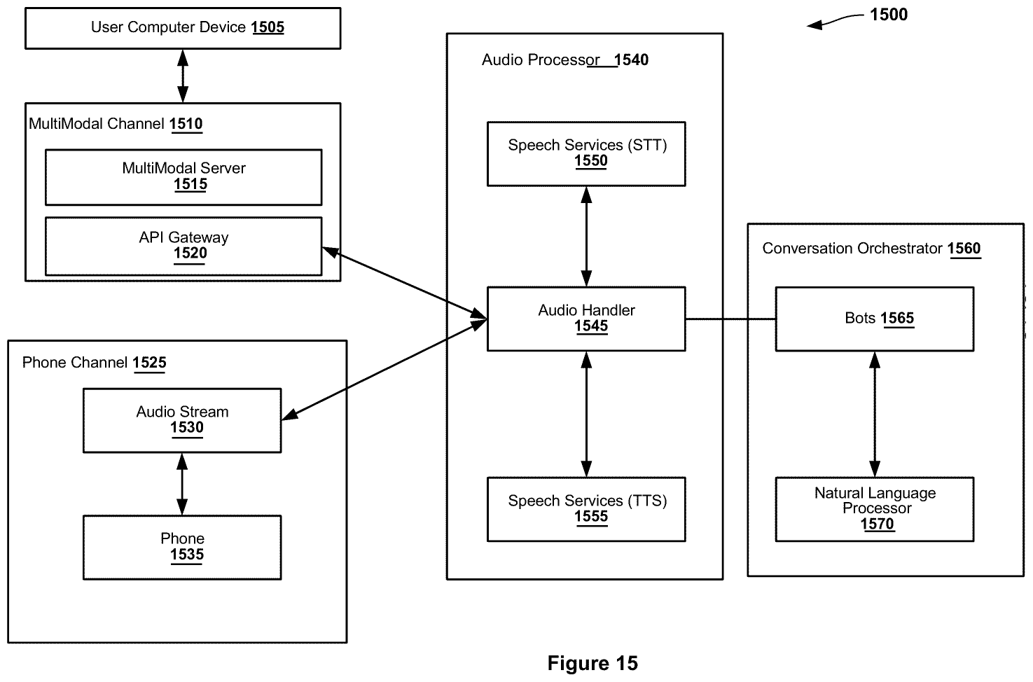

FIG. 14 illustrates an exemplary computer-implemented method 1400 for performing multimodal interactions with a user in accordance with at least one embodiment of the disclosure. In some embodiments, method 1400 may be implemented using one or more components of the SA computer system 200 (shown in FIG. 2). In other embodiments, method 1400 may be implemented using one or more components of the multimodal computer system 1500 (shown in FIG. 15).

The multimodal computer system 1500 is an enhancement to the SA computer system 200, where the multimodal computer system 1500 adds in one or more multimodal servers 1515 to provide the capability of responding to caller's verbal messages with more than just verbal responses. The multimodal computer system 1500 allows the SA computer system 200 to communicate with a plurality of user computer devices 1505 (shown in FIG. 15) and provide the callee with an enhanced communication experience and the chance to provide information in text and visual output while potentially receiving text and other inputs from the user computer device 1505.

In some embodiments, the SA computer device 205 (shown in FIG. 2) may also be in communication with one or more multimodal channels 1510 including one or more multimodal servers 1515 (both shown in FIG. 15) that may be used to combine the audio processing of the bots 708 with visual and/or text-based communication. Multimodal interactions include at least one additional channel of communication in addition to audio. For example, visual and/or text communication may be used to supplement and/or enhance the audio communication. In one example, a text statement of the user and/or caller may be added to a display screen to show the user how their words are being understood. Furthermore, a text statement may accompany an audio message from the bots to provide captions for the audio message. This extra communication could also be used for validation purposes.

In some embodiments, a user 1405 may be providing audio input 1410 to a user computer device 1415. In some embodiments, user 1405 may be a user attempting to conduct a conversation with an automated telephone service, reach customer services, interact with the user computer device 1415 to perform one or more tasks, and/or any other interaction with the user computer device 1415.

In some embodiments, audio input 1410 may be a phone call 104 (shown in FIG. 1). In some embodiments, user computer device 1415 may be similar to user computer device 102 (shown in FIG. 1) and/or user computer device 210 (shown in FIG. 2). The user computer device 1415 may be a mobile device, such as, but not limited to, a smart phone, a tablet, a phablet, a laptop, a desktop, smart contacts, smart glasses, augmented reality (AR) glasses, virtual reality (VR) headset, mixed reality (MR) glasses or headset, smart watch, and/or any other computer device that allows the user 1405 and the user computer device to communicate via audio and visual/text-based communications simultaneously, as described herein.

In some embodiments, the user computer device 1415 supports user touch interaction 1420 and user audio interaction 1425 through an application UI 1430. In some embodiments, the application UI 1430 is supported by the SA computer device 205 (shown in FIG. 2). In other embodiments, the application UI 1430 is supported by the multimodal server 1515 (shown in FIG. 15). The application UI 1430 is in communication with bot audio 1435, which may be supported by the SA computer device 205 and the orchestrator 240 (shown in FIG. 2) and/or the audio processor 1540 and the conversation orchestrator 1560 (both shown in FIG. 15).

In at least one embodiment, the user 1405 provides a user touch interaction 1420 by clicking a button on the application UI 1430 to start an assistant application. The application UI 1430 may display an Assistant View that may display “clickable” suggestions (or “touchable” suggestions on a touch screen or display) that the user 1405 may interact with. Furthermore, the application UI 1430 may prompt the bot audio 1435 to create an audio prompt. The application UI 1430 may then transmit the audio prompt to the user 1405. The user 1405 may then provide a response, such as the user audio interaction 1425 “I need to create a grocery list.” The bot audio 1435 processes the user audio interaction 1425 and generates a response “Sure lets get started, what would you like on your list?” The response is presented to the user 1405 via audio. The application UI 1430 may also update to show a grocery list view. In some embodiments, the grocery list view may display several previously added items and/or suggest items that are “clickable” by the user 1405, and/or that are selectable by the user's touch if the display has a touch screen.

Via the user audio interaction 1425, the user 1405 may provide one or more items for the grocery list. Via the user touch interaction 1420, the user 1405 may also select (click on) several items from the suggested items on the screen. Based upon the user touch interactions 1420 and the user audio interactions 1425, the application UI 1430 updates to show the grocery selections that were made.

When the user 1405 is finished with the list, the user 1405 may click (or touch) a “done” button as a user touch interaction 1420 or the user 1405 may say that they are done or finished as a user audio interaction 1425.

In some embodiments, the bot audio 1435 and/or the application UI 1430 may ask the user 1405 if there is anything else that they user 1405 wants to do, such as sharing the list with one or more others. In at least one embodiment, the others may be caregivers, roommates, flat mates, house mates, and/or others that may be interested in the grocery list. In some embodiments, the application UI 1430 displays a share list view that shows “clickable” (or touchable) suggestions of who to share the list with. The user 1405 may then provide user audio interaction 1425 and/or user touch interaction 1420 to provide one or more others to share the grocery list with. The application UI 1430 may then update the screen to let the user 1405 know that the tasks are complete. The bot audio 1435 may provide audio information confirming that the list has been shared.

While method 1400 describes creating a grocery list, the steps of method 1400 may be used for assisting the user 1405 in performing a plurality of different tasks. Some exemplary additional tasks may be or associated with (i) generating or receiving a quote for services (such as a quote for home owners, auto, life, renters, or personal articles insurance, a quote for home, vehicle, or personal loan, a quote for lawn keeping or vehicle maintenance services, etc.); (ii) handing insurance claims; (iii) generating, preparing, or submitting an insurance claim; (iv) handling parametric insurance claims; (v) purchasing goods or services online (such as buying electronics, mobile devices, televisions, etc.); and/or other tasks. Furthermore, providing interactions via both a display screen and/or microphone/speaker may assist the user 1405 to complete the task easily and efficiently.

### Exemplary Computer Network

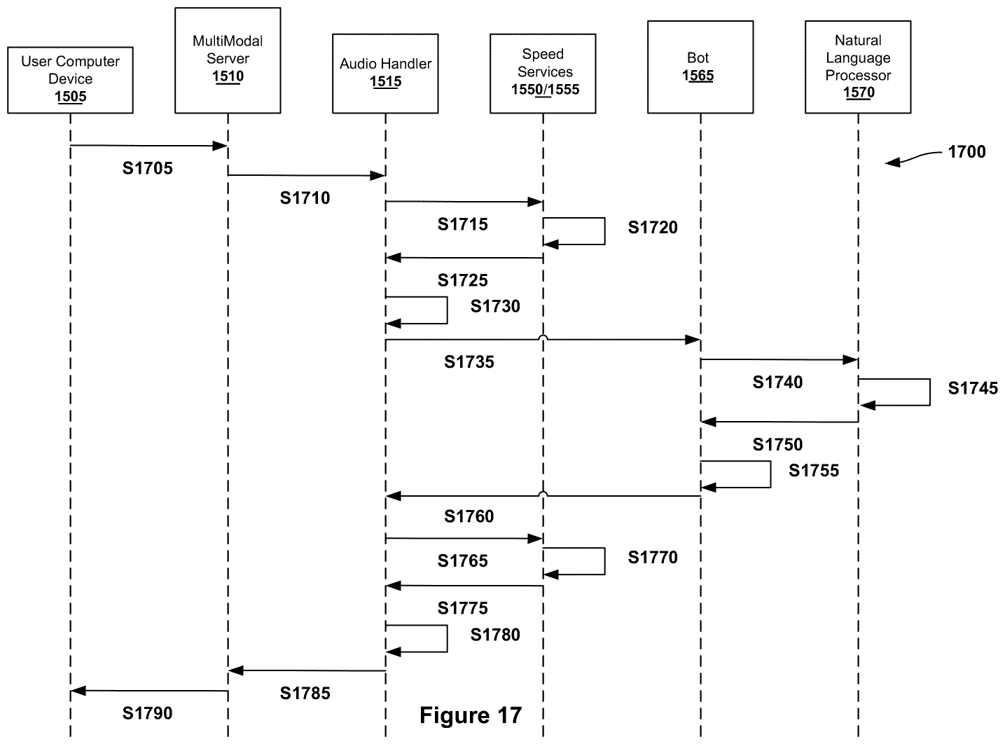

FIG. 15 illustrates a simplified block diagram of an exemplary multimodal computer system 1500 for implementing the computer-implemented method 1400 (shown in FIG. 14) and computer-implemented method 1700 (shown in FIG. 17). In the exemplary embodiment, multimodal computer system 1500 may be used for providing multimodal interactions with a user 1405 (shown in FIG. 14).

In the exemplary embodiment, the multimodal computer system 1500 is an enhancement of the SA computer system 200 (shown in FIG. 2). The multimodal computer system 1500 adds the ability to communicate with a plurality of channels 1510. In the exemplary embodiment, the audio processor 1540 is similar to the SA computer device 205 (shown in FIG. 2). In the exemplary embodiment, the multimodal computer system 1500 may be capable communicating with user computer devices 1505 over multimodal channels 1510 and phones 1535 over phone channels 1525. The multimodal computer system 1500 may be capable of communication with multiple user computer devices 1505 and/or multiple phones 1535 (and/or multiple touch screens) simultaneously.

The multimodal computer system 1500 may support voice based communications with users 1405 where the users 1405 may contact the multimodal computer system 1500 via phones 1535 and/or user computer devices 1505. The phone 1535 connection may be an audio only communication channel, while the user computer device 1505 supports both audio and text/visual communications, where the text/visual communications supplement and/or enhance the audio communications. In at least one embodiment, the user computer device 1505 may display text of what the user 1405 has said, as well as text of responses to the user 1405 that may also be presented audibly, such as via the application UI 1430 (shown in FIG. 14).

In some embodiments, the user computer device 1505 may be similar to user computer device 1415 (shown in FIG. 14), user computer device 102 (shown in FIG. 1), and/or user computer device 210 (shown in FIG. 2).

In the exemplary embodiment, user computer devices 1505 may include computers that include a web browser or a software application, which enables user computer devices 1505 to access remote computer devices, such as multimodal server 1515 and/or audio handler 1545, using the Internet, phone network, or other network. More specifically, user computer devices 1505 may be communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem.

User computer devices 1505 may be any device capable of accessing the Internet including, but not limited to, a desktop computer, a laptop computer, a personal digital assistant (PDA), a cellular phone, a smartphone, a tablet, a phablet, wearable electronics, smart watch, smart glasses, smart contacts, augmented reality (AR) glasses or headsets, virtual reality (VR) headsets, mixed or extended reality headsets or glasses, or other web-based connectable equipment or mobile devices. In some embodiments, user computer device 1505 may be in communication with a microphone. In some of these embodiments, the microphone is integrated into user computer device 1505. In other embodiments, the microphone may be a separate device that is in communication with user computer device 1505, such as through a wired connection (e.g., a universal serial bus (USB) connection).

In the exemplary embodiment, the user computer device 1505 connects to a multimodal channel 1510. A multimodal channel 1510 supports more than one type of communication, such as both audio and visual communication. The visual communication may be via text. The user computer device 1505 may use an application to connect to the multimodal channel 1510. The multimodal channel 1510 may include a multimodal server 1515 and/or an API gateway 1520. The multimodal server 1515 may control the application UI 1430, the user touch interactions 1420, and/or the user audio interaction 1425 (all shown in FIG. 14). The API gateway 1520 acts as middleware between the multimodal server 1515 and audio processor 1540. The audio processor 1540 allows the multimodal computer system 1500 to provide voice-based communications with the user 1405. These multimodal channels 1510 may include, but are not limited to, direct lines or voice chat via a program such as Skype, text chats, SMS messages, or other connections.

A phone channel 1525 supports audio communications. In at least one embodiment, the phone 1535 provides an audio stream 1530 to and from the audio processor 1540. In some embodiments, the audio stream 1530 may be similar to the audio stream 106 (shown in FIG. 1).

In the exemplary embodiment, the audio processor 1540 includes an audio handler 1545, speech services including speech to text (STT) 1550 and text to speech (TTS) 1555. In some embodiments, audio processor 1540 and/or audio handler 1545 may be similar to and/or a part of system 200 and/or SA computer device 205 (shown in FIG. 2). In some embodiments, text (STT) 1550 and text to speech (TTS) 1555 may be similar to STT service module 255 and TTS service module 250, respectively.

In the exemplary embodiment, the audio processor 1540 may receive conversation data, such as audio, from the user computer device 1505, the multimodal channels 1510, or a combination of the two. The audio processor 1540 may use internal logic to analyze the conversation data. The audio processor 1540 may determine whether the pauses in the conversation data represents the end of a statement or a user's turn of talking. The audio processor 1540 may fulfill the request from the user 1405 based upon the analyzed and interpreted conversation data.

The audio processor 1540 is in communication with a conversation orchestrator 1560. The conversation orchestrator 1560 includes a plurality of bots 1565 and a natural language processor 1570. In at least one embodiment, the conversation orchestrator 1560 may be similar to the orchestrator 240 (shown in FIG. 2). The bots 1565 may be similar to the chat bots of data 245 (shown in FIG. 2). And the conversation orchestrator 1560 and the bots 1565 may interact as described above in relation to the orchestrator 240 and the bots 710 (shown in FIG. 7).

In some embodiments, the audio processor 1540 may be in communication with the conversation orchestrator 1560 for analysis. The conversation orchestrator 1560 may be for analyzing the different intents and then parsing the intents into data. In insurance embodiments, the conversation orchestrator 1560 may parse the received intents into different categories of data 245. In this example, the conversation orchestrator 1560 may recognize categories of data 245 including: claim number, rental extension, rental coverage, rental payments, rental payment amount, liability, deductibles, endorsements, premiums, discounts, and rental coverage amount. In some embodiments, each of the categories of data 245 may have a dedicated chat bot 1565, and the conversation orchestrator 1560 may assign one of the dedicated chat bots 1565 to analyze, and respond to, the conversation data, or a portion of the conversation data.

In the exemplary embodiment, audio input is provided from the multimodal channel 1510 and/or the phone channel 1525 to an audio handler 1545 of the audio processor 1540. The audio handler 1545 transmits the audio input to the STT speech services 1550. The STT speech services 1550 translates the audio input into text and returns the text to the audio handler 1545. The audio handler 1545 transmits the text to the conversation orchestrator 1560 that determines which bot 1565 to transmit the text to. In at least one embodiment, the conversation orchestrator 1560 determines the intent of the text and chooses the bot 1565 associated with that intent. The bot 1565 confirms the intent from the text and generates a response. In some embodiments, the bot 1565 may run the response through the natural language processor 1570. The bot 1565 returns the response to the audio handler 1545. The audio handler 1545 transmits the response to the TTS speech service 1555 to convert the response into an audio response. The audio handler 1545 then determines which channel the audio response is for and transmits the audio response to the determined channel.

If the determined channel is the phone channel 1525, then the audio response is presented to the user 1405 via their phone 1535. If the determined channel is a multimodal channel 1510, the multimodal server 1515 reviews the audio response. In some embodiments, the multimodal server 1515 may cause the audio response to be presented to the user 1405 via their user computer device 1505. In further embodiments, the multimodal server 1515 also receives the text of the response and provides the text of the response to the user 1405 via the application UI 1430 on their user computer device 1505. In still additional embodiments, the multimodal server 1515 determines a supplemental response to the audio response, such as displaying a list of selectable grocery items (e.g., milk, bread, bacon, eggs, chicken, pizza, ice cream, soda, etc.) on the application UI 1430. In still further embodiments, the multimodal server 1515 determines a replacement response based upon the audio response and plays and/or displays the replacement response to the user 1405 via the user computer device 1505.

In some embodiments, the multimodal server 1515 and/or audio handler 1545 may be also in communication with one or more databases 260 (shown in FIG. 2). A database server (not shown) may be communicatively coupled to database 260. In one embodiment, database 260 may include parsed data 245, internal logic for parsing intents, conversation information, replacement responses, routing information, or other information as needed to perform the operations described herein. In the exemplary embodiment, database 260 may be stored remotely from the multimodal server 1515 and/or audio handler 1545. In some embodiments, database 260 may be decentralized. In the exemplary embodiment, the user may access database 260 via user computer device 1505 by logging onto the multimodal server 1515 and/or audio handler 1545, as described herein.

The multimodal server 1515 may be communicatively coupled with one or more user computer devices 1505. In some embodiments, the multimodal server 1515 may be associated with, or is part of a computer network associated with an insurance provider. In other embodiments, the multimodal server 1515 may be associated with a third party and is merely in communication with the insurer network computer devices. More specifically, the multimodal server 1515 may be communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem.

The multimodal server 1515 may be any device capable of accessing the Internet including, but not limited to, a desktop computer, a laptop computer, a personal digital assistant (PDA), a cellular phone, a smartphone, a tablet, a phablet, wearable electronics, smart watch, smart contact lenses, smart glasses, augmented reality glasses, virtual reality headsets, mixed or extended reality glasses or headsets, or other web-based connectable equipment or mobile devices. In the exemplary embodiment, the multimodal server 1515 may host an application or website that allows the user 1405 to access the functionality described herein. In some further embodiments, user computer device 1505 may include an application that facilitates communication with the multimodal server 1515.

In some further embodiments, multimodal computer system 1500 may also include a load balancer (not shown). The load balancer may route data between the audio handler 1545 and the bots 1565. In some embodiments, the data is provided in packets, where the headers may include information about the bot 1565 that the data is being routed to. The load balancer reads the heads and routes the packets accordingly. In some further embodiments, the load balancer may maintain one or more queues and store messages to be transmitted to different bots 1565. In these embodiments, the load balancer may determine whether or not a bot 1565 is currently working on a message and not send the bot 1565 additional messages until the bot 1565 is complete with the original message. In some further embodiments, there may be multiple copies of different bots 1565, where messages may be processed simultaneously. In these embodiments, the load balancer routes the messages to allow them to be processed efficiently. In some further embodiments, the load balancer can determine when additional bots 1565 need to be deployed.

### Exemplary Computer Network

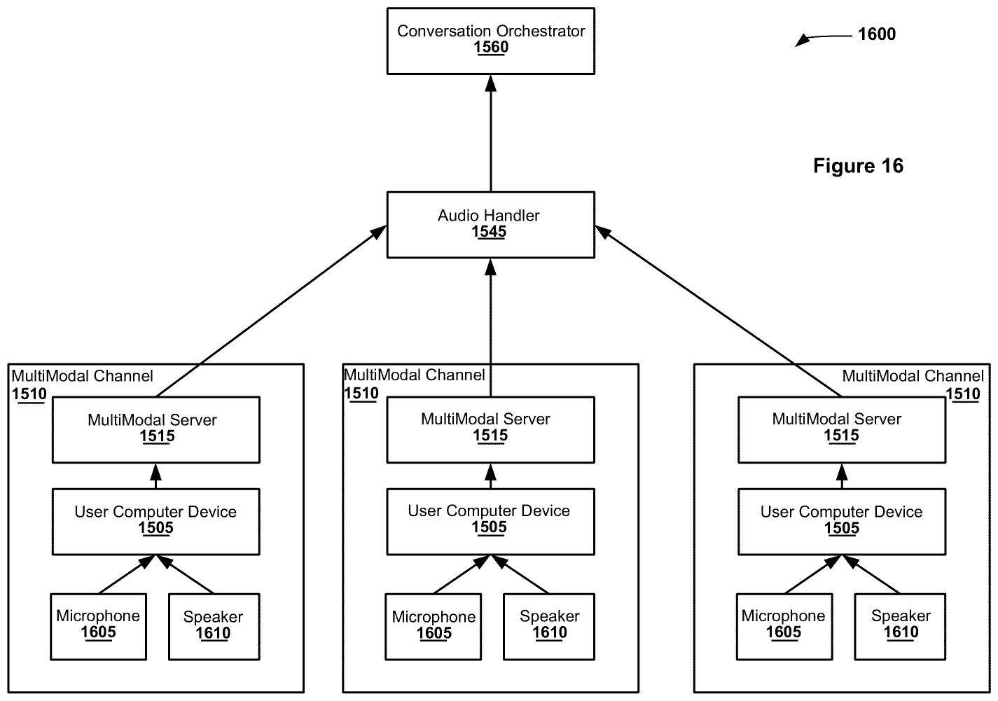

FIG. 16 illustrates a simplified block diagram of an exemplary multimodal computer system 1600 for implementing the computer-implemented method 1400 (shown in FIG. 14) and computer-implemented method 1700 (shown in FIG. 17). In the exemplary embodiment, multimodal computer system 1600 may be used for providing multimodal interactions with a plurality of users 1405 (shown in FIG. 14) on a plurality of user computer devices 1505 connected via a plurality of multimodal channels 1510.

In at least some embodiments, the plurality of user computer devices 1505 each may include a microphone 1605 and a speaker 1610, which allow the user 1405 to communicate audibly via the user computer device 1505. In some further embodiments, the user computer devices 1505 may include additional input 420 and media outputs 415 (both shown in FIG. 4), such as, but not limited to a display screen, a keyboard, a mouse, a touchscreen, AR glasses, VR headset, and/or other inputs 420 and media outputs 415 that allow the user 1405 to receive and provide information to and from the user computer device 1505 as described herein.

In the exemplary embodiment, the audio handler 1545 is in communication with a plurality of multimodal channels 1510 and is capable of conducting a plurality of conversations with a plurality of users 1405 via the multimodal channels 1510 simultaneously. The audio handler 1545 may receive audio inputs from the multimodal channels 1510, use the conversation orchestrator 1560 to determine responses to the audio inputs, and then route those responses to the appropriate multimodal channel 1510.

While FIG. 16 only shows multimodal channels 1510, the audio handler 1545 may also be in communication with a plurality of phone channels 1525 (shown in FIG. 15).

Exemplary Method for Multimodal Interactions with a User

FIG. 17 illustrates a timing diagram of an exemplary computer-implemented method 1700 for performing multimodal interactions with a user 1405 (shown in FIG. 14) in accordance with at least one embodiment of the disclosure. In the exemplary embodiment, the method 1700 may be performed by one or more of multimodal computer system 1500 (shown in FIG. 15) and multimodal computer system 1600 (shown in FIG. 16).

In the exemplary embodiment, the user computer device 1505 receives an audio input from the user 1405. The user computer device 1505 may be executing an application or web app that allows it to communicate with a multimodal server 1515. The multimodal server 1515 may be associated with a program and/or service that allows the user 1405 to communicate via audio (verbal) and text-based information. In at least one embodiment, the user computer device 1505 includes a touchscreen, a microphone 1605, and a speaker 1610 to communicate with the user 1405.

In step S1705, the user computer device 1505 transmits the audio input to the multimodal server 1515. In step S1710, the multimodal server 1515 forwards the audio input to the audio handler 1545. The audio handler 1545 transmits the audio input to the STT speech services 1550 in step S1715. Then the STT speech services 1550 converts S1720 the audio input into a text input. Next in step S1725, the STT speech services 1550 transmits the text input back to the audio handler 1545. In some embodiments, the audio handler 1545 may determine S1730 which bot 1565 to transmit S1735 the text input to based upon the content of the text input. In other embodiments, the audio handler 1545 transmits the text message to the conversation orchestrator 1560 (shown in FIG. 15) and the conversation orchestrator 1560 determines S1730 which bot 1565 to transmit the text input to. The bot 1565 receives S1735 the text input.

In some embodiments, the bot 1565 transmits S1740 the text input to a natural language processor 1570. The natural language processor 1570 analyzes S1745 the text in the text input and returns S1740 the analysis to the bot 1565. Then the bot 1565 processes the text input and generates S1750 a response. In other embodiments, the bot 1565 generates S1755 a response and transmits the response S1740 to the natural language processor 1570. The natural language processor 1570 reviews and adjusts S1745 the response. The adjusted response is returned S1750 to the bot 1565. The bot 1565 transmits S1760 the response to the audio handler 1545.

The audio handler 1545 transmits S1765 the response to the TTS speech services 1555. Then the TTS speech services 1555 converts S1770 the response into a n audio response. The TTS speech services 1555 transmits S1775 the audio response back to the audio handler 1545.

The audio handler 1545 determines S1780 which multimodal channel 1510 to transmit S1785 the audio response on. In some embodiments, the audio handler 1545 transmits S1785 both the audio response and the text version of the response to the multimodal server 1515. The multimodal server 1515 transmits S1790 one or more of the audio response, the text response (or touch response), a supplemental response, and/or a replacement response to the user computer device 1505 to be presented to the user 1405.

In some embodiments, the multimodal server 1515 reviews the response and determines a replacement response and/or a supplemental response to be provided to the user 1405. In the grocery list example shown in FIG. 14, the multimodal server 1515 determines to display several previously added or commonly selected items (e.g., soup, crackers, orange juice, etc.) to be clicked to be added to the grocery list. This is in addition to causing the user computer device 1505 to audibly play the message “Sure lets get started. What would you like on your list?”, or “Anything else?” once one or more items have been added to the grocery list via text or touch user input.

In a further embodiment, the user computer device 1505 receives one or more selections or a text input (and/or touch input) from the user 1405. For example, the selections could be for grocery items or the text input (and/or touch input) could be a search command for a specific grocery item. In these embodiments, the multimodal server 1515 receives S1705 the selection and/or text input (and/or touch input). The multimodal server 1515 may then determine what information to provide to user 1405. The multimodal server 1515 may decide to read the selected grocery items and/or text input (and/or touch input) back to the user 1405 via the user computer device 1505. The multimodal server 1515 transmits the information to the audio handler 1545.

In these embodiments, the audio handler 1545 may provide the selected grocery items (such as grocery items selected by user voice input, user text input, and/or user touch input) to the TTS speech services 1555 and then provide the audio listing of the items to the multimodal server 1515 to be presented to the user 1405. In other embodiments, the audio handler 1545 provides the selected items and/or the text input (and/or touch input) to a bot 1565, which generates an audio response, such as, “unsalted butter, is this correct?”, which is then presented to the user 1405.

In some embodiments, the user may then respond to the audio response via (i) voice input to be heard by one or more voice bots, (ii) text input that is input by the user typing input on a user interface via a keyboard, and/or (iii) touch input that is input by the user touching a touch display screen and user interface. The audio handler 1545 may modify the order of devices accessed and/or which devices are accessed based upon information from the multimodal server 1515 such as that information provided with the audio input and/or text input (and/or touch input).

In the exemplary embodiment, method 1700 may be used to provide information to and receive information from the user 1405 on channels other than an audio channel. This provides additional functionality such as validation of the audio inputs. For example, multimodal computer system 1500 may receive an audio input from a user 1405 and display a text version of the audio input on an application UI 1430 for the user 1405 to confirm that it is correct. Furthermore, any audio response provided to the user 1405 may also be displayed to the user 1405 on the application UI 1430. The application UI 1430 may also provide pictures in addition to text on the visual display. In some embodiments, where a user 1405 is providing information, such as filling out a form audibly, the application UI 1430 may display the information as it is being provided to and filled out on the form.

In some embodiments, the audio handler 1545 adds a header to received audio inputs, text inputs, touch inputs, and/or audio/text/touch responses. In other embodiments, the multimodal server 1515 adds headers. In still further embodiments, bot the multimodal server 1515 and the audio handler 1545 add and/or modify headers of data being transmitted and received.

In still further embodiments, the audio handler 1545 and/or the multimodal server 1515 attached session IDs and/or conversation IDs to inputs and responses to ensure that the appropriate inputs are associated with the corrects responses.

In some further embodiments, the SA computer device 205 includes one or more of the audio handler 1545, the multimodal server 1515, and/or the conversation orchestrator 1560.

In at least one embodiment, the MultiModal Server 1515 includes at least one processor 505 and/or transceiver in communication with at least one memory device 510. The MultiModal Server 1515 may also include a voice bot 1565 configured to accept user voice input and provide voice output. The MultiModal Server 1515 may further include at least one input and output communication channel 1510 configured to accept user input 1410 and provide output to the user 1405, wherein the at least one input and output communication channel 1510 is configured to communicate with the user via a first channel 1510 of the at least one input and output communication channel 1510 and the voice bot 1565 simultaneously, nearly simultaneously, or nearly at the same time.

In at least one further embodiment, the MultiModal Server 1515 may be programmed to engage the user 1405 in separate exchanges of information with the computer system 1500 simultaneously, nearly simultaneously, or nearly at the same time via the at least one input and output communication channel 1510 and the voice bot 1565.

In some embodiments, the first channel 1510 includes a touch display screen 415 having a graphical user interface configured to accept user touch input 420. In some further embodiments, the first channel 1510 includes a display screen 415 having a graphical user interface. The MultiModal Server 1515 may accept user selectable input via a mouse 420 or other input device 420 and the display screen 415.

In some embodiments, the MultiModal Server 1515 may receive the user input 1410 from one or more of the at least one input and output communication channel 1510 and the voice bot 1565. The MultiModal Server 1515 may transmit the user input to at least one audio handler 1545. The MultiModal Server 1515 may receive a response from the at least one audio handler 1545. The MultiModal Server 1515 may provide the response via the at least one input and output communication channel 1510 and the voice bot 1565.

In some embodiments, the MultiModal Server 1515 may generate a first response and a second response based upon the response. The first response and the second response may be different. The MultiModal Server 1515 may provide the first response to the user 1405 via the at least one input and output channel 1510. The MultiModal Server 1515 may provide the second response to the user via the voice bot 1565.

In some embodiments, the MultiModal Server 1515 may receive the user input 1410 via the voice bot 1565. The MultiModal Server 1515 may provide the response via the at least one input and output channel 1510. The MultiModal Server 1515 may provide the response via the voice bot 1565 and the at least one input and output channel 1510 simultaneously.

In some embodiments, the user input and the output relate to and/or are associated with insurance. In some further embodiments, the user touch input and the user voice input relate to and/or are associated with parametric insurance and/or parametric insurance claim. Parametric insurance is related to and/or associated with collecting and analyzing data, monitoring the data (such as sensor data), and when a threshold or trigger event is detected from analysis of the data, generating an automatic or other payout under or pursuant to an insurance claim.

### Exemplary Computer Network

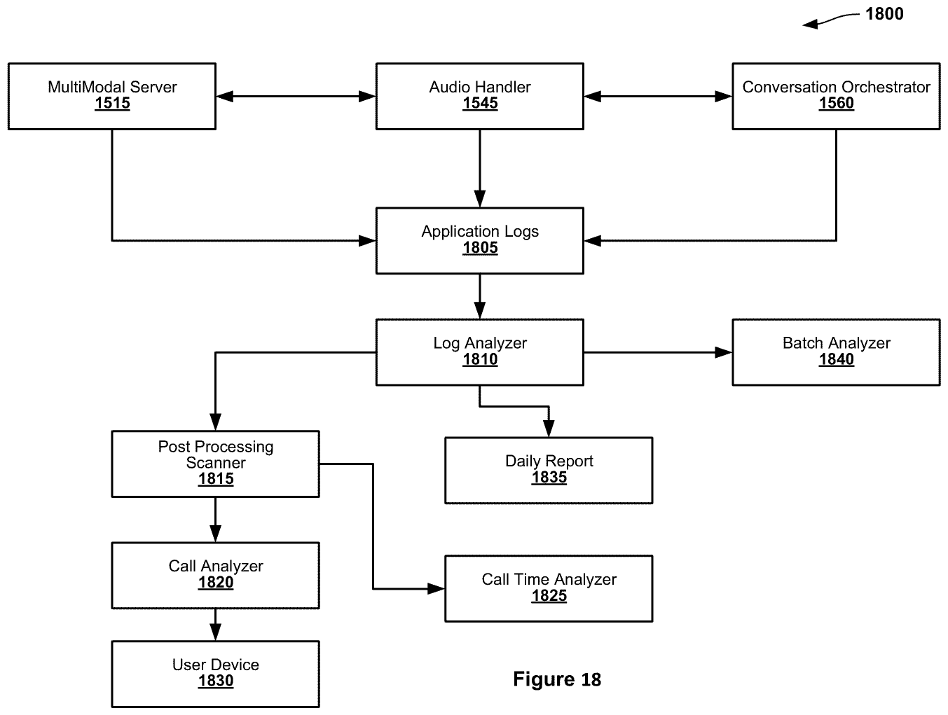

FIG. 18 illustrates a simplified block diagram of an exemplary computer system 1800 for monitoring logs of the multimodal computer system 1500 (shown in FIG. 15) and 1600 (shown in FIG. 16) while implementing the computer-implemented methods 1400 (shown in FIG. 14) and 1700 (shown in FIG. 17). In the exemplary embodiment, computer system 1800 may be used for scanning and analyzing the actions of network 16 to detect issues and/or problems.

In the exemplary embodiment, one or more of the multimodal server 1515, the audio handler 1545, and the conversation orchestrator 1560 may generate application logs 1805 of their actions. For example, each action of the multimodal server 1515, the audio handler 1545, and/or the conversation orchestrator 1560 may be automatically stored in a log along with details about that action. Additionally or alternatively, if it is determined that needed data is missing to answer the user's query, the network 1500 may log that that data is missing and ask the user 1405 (shown in FIG. 14) to provide the missing data.

In at least one embodiment, each series of interactions with a user 1405 are associated with an identifier, such as a conversation ID. This conversation ID is added to the logs with the action to allow the system 1800 to determine which actions go with each conversation and therefore each user 1405. Below in TABLE 1 is an example listing of log sequence events that may be stored in a log. The call sequence events are significant events that occurred during a conversation with a user 1405, such as a call with the user 1405.

| | |
|---|---|
| >Sep. 1, 2022 @ 09:45:10.025 | NEW_CALL |
| >Sep. 1, 2022 @ 09:45:11.272 | BOT_TURN_FINISHED |
| >Sep. 1, 2022 @ 09:45:11.273 | SOLICALL_INITIALIZED_FOR_CALL |
| >Sep. 1, 2022 @ 09:45:35.734 | BOT_TURN_FINISHED |
| >Sep. 1, 2022 @ 09:45:44.951 | KNOWN_BUSINESS_NAME_IDENTIFIED |
| >Sep. 1, 2022 @ 09:45:45.015 | BOT_TURN_FINISHED |
| >Sep. 1, 2022 @ 09:45:57.258 | INVALID_UTTERANCE |
| >Sep. 1, 2022 @ 09:45:57.276 | BOT_TURN_FINISHED |
| >Sep. 1, 2022 @ 09:46:10.416 | KNOWN_BUSINESS_NAME_IDENTIFIED |
| >Sep. 1, 2022 @ 09:46:10.479 | BOT_TURN_FINISHED |
| >Sep. 1, 2022 @ 09:46:22.439 | BOT_TURN_FINISHED |
| >Sep. 1, 2022 @ 09:46:40.767 | CLAIM_NOT_FOUND |
| >Sep. 1, 2022 @ 09:46:40.996 | BOT_TURN_FINISHED |
| >Sep. 1, 2022 @ 09:47:02.121 | BOT_TURN_FINISHED |
| >Sep. 1, 2022 @ 09:47:21.282 | CLAIM_FOUND_OPEN |
| >Sep. 1, 2022 @ 09:47:21.419 | BOT_TURN_FINISHED |
| >Sep. 1, 2022 @ 09:47:40.332 | VEHICLE_CLAIMANT_MATCHED |
| >Sep. 1, 2022 @ 09:47:40.768 | PARTICIPANT_MATCHED |
| >Sep. 1, 2022 @ 09:47:41.942 | BOT_TURN_FINISHED |
| >Sep. 1, 2022 @ 09:47:56.371 | BOT_TURN_FINISHED |
| >Sep. 1, 2022 @ 09:48:13.690 | BOT_TURN_FINISHED |
| >Sep. 1, 2022 @ 09:48:43.663 | ELICITED_DATA_CONFIRMED |
| >Sep. 1, 2022 @ 09:48:46.767 | RENTAL_CREATE_SUCCESS |
| >Sep. 1, 2022 @ 09:48:46.826 | BOT_TURN_FINISHED |
| >Sep. 1, 2022 @ 09:49:01.521 | BOT_TURN_FINISHED |
| >Sep. 1, 2022 @ 09:49:08.721 | BOT_TURN_FINISHED |
| >Sep. 1, 2022 @ 09:49:26.211 | SOLICALL_EVALUATION |
| >Sep. 1, 2022 @ 09:49:41.172 | REPROMPT_DELAYED_RESPONSE_SENT |
| >Sep. 1, 2022 @ 09:49:41.172 | BOT_TURN_FINISHED |
| >Sep. 1, 2022 @ 09:50:00.610 | BOT_TURN_FINISHED |

The above call sequence events include when each bot 1565 (shown in FIG. 15) finished its turn, such as at the end of an utterance and when data provided by the user matched stored data.

The application logs 1805 are then provided to a log analyzer 1810 for further analysis. The log analyzer 1810 may be configured to provide multiple different types of analysis. These types of analysis may include, but are not limited to, a post processing scan of the application logs 1805 on a regular basis, a daily report 1835 of all of the logs for a day, and a batch analysis of a large number of logs over a period of time.

In at least one embodiment, a post processing scanner 1815 analyzes the application logs 1805 on a periodic basis to detect issues. In some embodiments, the post processing scanner 1815 performs its analysis every few minutes (e.g., five minutes). This analysis may only be on calls that completed within the last period, or all calls and actions that have occurred within the last call period. The post processing scanner 1815 collates the application logs 1805 by conversation ID to analyze each conversation or call.

In some further embodiments, the post processing scanner 1815 is in communication with a call analyzer 1820 and/or a call time analyzer 1825. The call analyzer 1820 may perform classification of each call or conversation and then perform an aggregation of all of the calls or conversations analyzed to detect any errors. The call analyzer 1820 may then report the detected errors to a user device 1830, such as a mobile phone or other computer device. For example, if the call analyzer 1820 detects multiple log entries indicating that the audio handler 1545 is not responding, the call analyzer 1820 may then report those errors to one or more individuals, such as IT professionals, who may be able to fix the problem behind the error. In some embodiments, the call analyzer 1820 may transmit the detected errors through an SMS message, an MMS message, a text message, an instant message and/or an email. The call analyzer 1820 may also call the user device 1830 with an automated verbal message.

In at least one embodiment, a call or conversation summarization may include call or conversation classifications. The call summary may be the evaluation of a call or conversation. The call summary may be run by the call analyzer 1820 five minutes after a call or conversation. The call summary may be a rerun on every call as part of the batch process performed by the batch analyzer 1840. The call summary may contain a summary of all of the data that occurred in a call or conversation along with categorizations of that call or conversation.

Information provided in the call summary may include, but is not limited to, timestamp, counts, _id, botFlavor, bot outcome, branchID, businessClassification, callOutcome, callerNumber, validCall, claimNumberDetailed Classification, claimNumberSimpleClassification, rentalIneligibilityClassification, rentalIneligibilityReasonCodes, and/or any other desired information.

The timestamp may be sourced from the NEW_CALL event, which indicated the beginning of the call or conversation. As there is always one of these events per call and the summary can be correlated to the time of the call. Counts refers to every field that ends with [Event Name]_COUNT may be a tally of how many events occurred with that name on the call. _id may be a unique id comprised of Conversation ID and CALL_SUMMARY.

botFlavor is an indicator used to discern what bot use case/version is related this call is related to. botOutcome may be an indicator or an overgeneralization of how the call or conversation went from a bot perspective. This may ignore the business case. botOutcome looks at if the caller (user 1405) was understood and example results include, but are not limited to: Completed Call Flawlessly; Caller Not Understood; and Completed Successfully With Errors.

branchID may be the branch id caller provided during call or conversation, such as branch of the business or if the user 1405 was asking to build or add to a grocery list. businessClassification further classifies the call or conversation based upon whether or not the call or conversation had any business value at all. For example, in an insurance embodiment, if a rental was successful the businessClassification is considered high value. Furthermore, if user 1405 was able to provide a claim number to the bot 1565 it is considered medium value (e.g., something was learned from the interaction), otherwise it is considered to have no value. In another embodiment, if the user 1405 placed a grocery order, then the classification may be high value, while if items were added to the grocery list it may be of medium value.

callOutcome is an overgeneralization of what the outcome of the call was. The outcomes may include, but are not limited to: Unknown; Rental Success; Rental Not Eligible; Caller Quick Transfer; Caller Not Engaged; Max Failed Attempts; Caller Not Prepared; Quick Hang-up; Call Aborted; Bot Initiated Transfer; Bot Technical Issues; Caller Requested Transfer; Claim Not Found—Transfer; Caller Was Transferred—Undetermined; Vehicle Not Found; and or any other status desired.

callerNumber is the number caller called from. This may also be a device, application, or account identifier if the user 1405 used a user computer device 1505 (shown in FIG. 15) instead of a phone 1535.

claimNumberDetailedClassification is a classification of how eliciting the claim number or account number went with granular details. The details may include, but are not limited to: Confirmed Incorrect; Confirmed Correct—Single Attempt; Confirmed Correct—Multiple Attempts; Confirmed Correct—Not Found; Not Applicable; Unconfirmed—Aborted; Unconfirmed—Transferred; Unknown; and/or any other details desired.

claimNumberSimpleClassification is a classification of how eliciting the claim number went with simple details. The details may include, but are not limited to: Not Applicable; Confirmed Correct; Unknown; Confirmed Incorrect; and/or any other details desired.

In an insurance embodiment, rentalIneligibilityClassification may describe the reason the call or conversation was not eligible. This may be enhanced with rentalIneligibleReasonCodes, wherein codes may represent reasons which the call or conversation was not eligible. For example, the codes may include: C1: “Policy is not in force”; C2: “Excluded driver exists”; C3: “Claim status is other than new, open, or reopen”; C4: “The date reported is 180 days or more after the date of loss”; C5: “Vehicle being used for business”; C6: “Collision coverage doesn't exist for collision claim”; C7: “Passenger transported for a fee”; C8: “Comprehensive coverage doesn't exist for comprehensive claim”; C9: “Default address is Canadian”; C10: “Claim state code is Canadian”; C11: “Vehicle is specialty vehicle”; RP1: “The participant's vehicle year is blank”; RP2: “The claim is marked as Catastrophe claim”; RP3: “The participant's vehicle make is blank”; RP4: “Participant's role is not either Named Insured or Claimant Owner”; RP5: “A repair assignment exists for associated vehicle”; RP6: “The cause of loss is invalid”; RP7: “The vehicle is not damaged”; RP8: “Liability has not been established at 100% against the Named Insured”; RP9: “The claimant does not have a 200 COL in a valid status”; RP10: “Property liability dollar limit is less than 25,000 and Single Limit liability is less than 1,000,000”; RP11: “A vehicle does not exist”; RP12: “Multiple Claimants have 200 COL in a valid status”; RP13: “An estimate exists for the associated participant”; RP14: “COL or probable COL type is invalid”; RP15: “The vehicle is marked as an Expedited Total Loss”; E01: “The Claim State Code is ineligible for estimates”; E02: “The vehicle is not driveable”; UNSPECIFIED: “The Eligibility Service Determined this not eligible, but provided no reason”; CLAIM_CLOSED: “The claim was closed”; CLAIM_LOCKED: “The claim is not accessible when a user a process is updating something on a claim”; and or any other desired reason code.

validCall is a flag that may be used to identify calls that interact with the bot 1565. If the user 1405 was a quick hang up, quick transfer, caller was not engaged, connection error, or user 1405 was one of support team members, the call is flagged not valid.

TABLE 2 illustrates an example call summary based upon the above definitions. Other call summaries may be different based upon the desired and analyzed data and the individual call and/or conversation.

TABLE 2

| @timestamp | Sep. 1, 2022 @ 09:45:10.025 |
|---|---|
| # ADJUSTED_ALPHA_NUMBER_PERIPHERAL_COUNT | 7 |
| # BOT TURN FINISHED COUNT | 17 |
| # CLAIM_FOUND_OPEN_COUNT | 1 |
| # CLAIM_NOT_FOUND_COUNT | 1 |
| # ELICITED_DATA_CONFIRMED_COUNT | 1 |
| # INVALID UTTERANCE COUNT | 1 |
| # KNOWN_BUSINESS_NAME_IDENTIFIED_COUNT | 2 |
| # NEW_CALL_COUNT | 1 |
| # PARTICIPANT_MATCHED_COUNT | 1 |
| # RENTAL CREATE SUCCESS COUNT | 1 |
| # REPROMPT_DELAYED_RESPONSE_SENT_COUNT | 1 |
| # ULTIMATE_PERFECT_CALL | 1 |
| # VEHICLE_CLAIMANT_MATCHED_COUNT | 1 |
| t_id | 7e5648e7-5c06-4904-b195-379074bde6aa- |
| | CALL_SUMMARY |
| t index | business call analysis |
| # _score | — |
| t_type | _doc |
| t botFlavor | InitialRental |
| t botOutcome | Completed Call Flawlessly |
| t branchID | 1729 |
| t businessClassification | High Value |
| t businessEvent | CALL_SUMMARY |
| t callDuration | 00:00:00 |
| # callDurationSeconds | 0 |
| callEndTime | Jan. 31, 2020 @ 18:00:00.000 |
| t callOutcome | Rental Success |
| callStartTime | Sep. 1, 2022 @ 09:45:10.025 |
| t callerNumber | +15555555 |
| t claimNumberDetailedClassification | Confirmed Correct; Single Attempt |
| t claimNumberSimpleClassification | Confirmed Correct |
| t claimNumbers | 3834T895K |
| t conversationID | 7e5648e7-5c06-4904-b195-379074bde6aa |
| date | Sep. 1, 2022 @ 09:45:10.025 |
| # estimatedMinutesSaved | 5 |
| t name | CALL_SUMMARY |
| t participantType | Claimant |
| validCall | True |
| t vendor | ENTERPRISE |
| t version | 1.0 |
| t voicebotClassification | Calls Completed Successfully |

In some further embodiment, the call time analyzer 1825 analyzes each call or conversation for performance metrics, such as but not limited to, how long did the call or conversation take, did it complete successfully, if not then why did the call or conversation fail, and/or other details about the call or conversation. The results of the call time analyzer 1825 may be used to improve the performance of the multimodal computer system 1500 including suggesting features, such as additional bots 1565 and/or computer resources that may be needed.

In still further embodiments, the log analyzer 1810 may generate a daily report 1835 to classify each of the calls and/or conversations that have occurred during the day in question. This may also be other periods of time, such as, but not limited to, weeks, months, hours, and/or any other desired division of time for the report. TABLE 3 illustrates an example daily report 1835.

TABLE 3

| | |
|---|---|
| Total Calls | 96 |
| Total Valid Calls | 64 |
| Rental Success | 9 @ 14.1% |
| Rental Not Eligible | 34 @ 53.1% |
| Max Failed Attempts | 6 @ 9.4% |
| Call Aborted | 3 @ 4.7% |
| Claim Not Found; Transfer | 4 @ 6.3% |
| Bot Initiated Transfer | 3 @ 4.7% |
| Caller Not Prepared | 4 @ 6.3% |
| Caller Requested Transfer | 1 @ 1.6% |

The batch analyzer 1840 may be used to analyze a large number of calls and/or conversations to determine how the systems are working. This batch report may provide insights into trends and other issues and/or opportunities.

The system 1800 may include additional analysis based upon the needs and desires of those running the computer systems 1500 and 1800.

In some embodiments, the system 1800 may store a plurality of completed conversations. Each conversation of the plurality of completed conversations includes a plurality of interactions between a user 1405 and a voice bot 1565. The system 1800 may also analyze the plurality of completed conversations. The system 1800 may further determine a score for each completed conversation based upon the analysis, the score indicating a quality metric for the corresponding conversation. Additionally, the system 1800 may generate a report based upon the plurality of scores for the plurality of completed conversations.

In some further embodiments, the system 1800 may store the plurality of completed conversations in one or more logs 1805 within the at least one memory device 410. Each conversation may be associated with a unique conversation identifier. The system 1800 may extract each conversation for analysis based on the corresponding unique conversation identifier. The one or more logs 1805 may include each interaction between the user 1405 and the voice bot 1565.

In some additional embodiments, the report may include a list of labels associated with each conversation, wherein the labels include at least one of “no claim number,” “call aborted,” “lack of information,” or “no claim information.”

In still additional embodiments, the system 1800 may identify one or more call sequence events in each conversation of the plurality of completed conversations. The call sequence events for each conversation may represent predefined events that occurred during the corresponding conversation.

In further embodiments, the system 1800 may classify each completed conversation based upon the analysis of the corresponding conversation. The analysis of the corresponding conversation may include determining which actions were taken by the voice bot 1565 in response to one or more actions of the user 1405.

In additional embodiments, the system 1800 may aggregate the plurality of analyzed conversations to detect one or more errors in the plurality of analyzed conversations. The one or more errors include whether the voice bot 1565 correctly interpreted the purpose of the incoming call, correctly directed the call to the proper location, provided the proper response and/or resolved the caller's issue or request.

In still additional embodiments, the system 1800 report the one or more detected errors.

In additional embodiments, the system 1800 may transmit information about the one or more detected errors to a computer device associated with an information technology professional.

In still additional embodiments, the system 1800 may analyze a plurality of conversations completed within a first period of time.

In further embodiments, the system 1800 analyze each conversation within a first period of time after the conversation has completed.

In still further embodiments, the system 1800 may determine a reason for the conversation. The system 1800 may determine if the reason for the conversation was completed during the conversation.

### Machine Learning and Other Matters

The computer-implemented methods discussed herein may include additional, less, or alternate actions, including those discussed elsewhere herein. The methods may be implemented via one or more local or remote processors, transceivers, servers, and/or sensors (such as processors, transceivers, servers, and/or sensors mounted on vehicles or mobile devices, or associated with smart infrastructure or remote servers), and/or via computer-executable instructions stored on non-transitory computer-readable media or medium.

In some embodiments, SA computing device 205 is configured to implement machine learning, such that SA computing device 205 “learns” to analyze, organize, and/or process data without being explicitly programmed. Machine learning may be implemented through machine learning methods and algorithms (“NIL methods and algorithms”). In an exemplary embodiment, a machine learning module (“ML module”) is configured to implement ML methods and algorithms. In some embodiments, ML methods and algorithms are applied to data inputs and generate machine learning outputs (“ML outputs”). Data inputs may include but are not limited to speech input statements by user entities. ML outputs may include but are not limited to: identified utterances, identified intents, identified meanings, generated responses, and/or other data extracted from the input statements. In some embodiments, data inputs may include certain ML outputs.

In some embodiments, at least one of a plurality of ML methods and algorithms may be applied, which may include but are not limited to: linear or logistic regression, instance-based algorithms, regularization algorithms, decision trees, Bayesian networks, cluster analysis, association rule learning, artificial neural networks, deep learning, combined learning, reinforced learning, dimensionality reduction, and support vector machines. In various embodiments, the implemented ML methods and algorithms are directed toward at least one of a plurality of categorizations of machine learning, such as supervised learning, unsupervised learning, and reinforcement learning.

In one embodiment, the ML module employs supervised learning, which involves identifying patterns in existing data to make predictions about subsequently received data. Specifically, the ML module is “trained” using training data, which includes example inputs and associated example outputs. Based upon the training data, the ML module may generate a predictive function which maps outputs to inputs and may utilize the predictive function to generate ML outputs based upon data inputs. The example inputs and example outputs of the training data may include any of the data inputs or ML outputs described above. In the exemplary embodiment, a processing element may be trained by providing it with a large sample of conversation data with known characteristics or features. Such information may include, for example, information associated with a plurality of different speaking styles and accents.

In another embodiment, a ML module may employ unsupervised learning, which involves finding meaningful relationships in unorganized data. Unlike supervised learning, unsupervised learning does not involve user-initiated training based upon example inputs with associated outputs. Rather, in unsupervised learning, the ML module may organize unlabeled data according to a relationship determined by at least one ML method/algorithm employed by the ML module. Unorganized data may include any combination of data inputs and/or ML outputs as described above.

In yet another embodiment, a ML module may employ reinforcement learning, which involves optimizing outputs based upon feedback from a reward signal. Specifically, the ML module may receive a user-defined reward signal definition, receive a data input, utilize a decision-making model to generate a ML output based upon the data input, receive a reward signal based upon the reward signal definition and the ML output, and alter the decision-making model so as to receive a stronger reward signal for subsequently generated ML outputs. Other types of machine learning may also be employed, including deep or combined learning techniques.

Based upon these analyses, the processing element may learn how to identify characteristics and patterns that may then be applied to analyzing conversation data. For example, the processing element may learn, with the user's permission or affirmative consent, to identify the most commonly used phrases and/or statement structures used by different individuals from different geolocations. The processing element may also learn how to identify attributes of different accents or sentence structures that make a user more or less likely to properly respond to inquiries. This information may be used to determine which how to prompt the user to answer questions and provide data.

### EXEMPLARY EMBODIMENTS

In one aspect, a speech analysis (SA) computer device may be provided. The SA computing device may include at least one processor in communication with at least one memory device. The SA computer device may be in communication with a user computer device associated with a user. The at least one processor may be configured to: (1) receive, from the user computer device, a verbal statement of a user including a plurality of words; (2) translate the verbal statement into text; (3) detect one or more pauses in the verbal statement; (4) divide the verbal statement into a plurality of utterances based upon the one or more pauses; (5) identify, for each of the plurality of utterances, an intent using an orchestrator model; (6) select, for each of the plurality of utterances, based upon the intent corresponding to the utterance, a bot to analyze the utterance; and/or (7) generate a response by applying the bot selected for each of the plurality of utterances to the corresponding utterance. The SA computing device may include additional, less, or alternate functionality, including that discussed elsewhere herein.

An enhancement of the SA computing device may include a processor configured to translate the response into speech; and transmit the response in speech to the user computer device.

A further enhancement of the SA computing device may include a processor configured to generate the response by determining a priority of each of the plurality of utterances based upon the intents corresponding to each of the plurality of utterances; and process each of the plurality of utterances in an order corresponding to the determined priority of each utterance.

A further enhancement of the SA computing device may include a processor configured to identify an entity associated with the user; assign a role to the entity based upon the identification; and generate the response further based upon the role assigned to the entity.

A further enhancement of the SA computing device may include a processor configured to extract a meaning of each of the plurality of utterances by applying the bot selected for the corresponding utterance to each of the plurality of utterances.

A further enhancement of the SA computing device may include a processor configured to determine, based upon the meaning extracted for the utterance, that the utterance corresponds to a question; determine, based upon the meaning, a requested data point that is being requested in the question; retrieve the requested data point; and generate the response to include the requested data point.

A further enhancement of the SA computing device may include a processor configured to determine, based upon the meaning extracted from the utterance, that the utterance corresponds to a provided data point that is being provided through the utterance; determine, based upon the meaning, a data field associated with the provided data point; and store the provided data point in the data field within a database.

A further enhancement of the SA computing device may include a processor configured to determine, based upon the meaning, that additional data is needed from the user; generate a request to the user to request the additional data; translate the request into speech; and transmit the request in speech to the user computer device.

A further enhancement of the SA computing device may include a processor wherein the verbal statement is received via at least one of a phone call, a chat program, and a video chat.

In another aspect, a computer-implemented method may be provided. The computer-implemented method may be performed by a speech analysis (SA) computer device including at least one processor in communication with at least one memory device. The SA computer device may be in communication with a user computer device associated with a user. The method may include: (1) receiving, by the SA computer device, from the user computer device, a verbal statement of a user including a plurality of words; (2) translating, by the SA computer device, the verbal statement into text; (3) detecting, by the SA computer device, one or more pauses in the verbal statement; (4) dividing, by the SA computer device, the verbal statement into a plurality of utterances based upon the one or more pauses; (5) identifying, by the SA computer device, for each of the plurality of utterances, an intent using an orchestrator model; (6) selecting, by the SA computer device, for each of the plurality of utterances, based upon the intent corresponding to the utterance, a bot to analyze the utterance; and/or (7) generating, by the SA computer device, a response by applying the bot selected for each of the plurality of utterances to the corresponding utterance. The computer-implemented method may include additional, less, or alternate actions, including those discussed elsewhere herein.

An enhancement of the computer-implemented method may include translating, by the SA computer device, the response into speech; and transmitting, by the SA computer device, the response in speech to the user computer device.

A further enhancement of the computer-implemented method may include generating, by the SA computer device, the response by determining a priority of each of the plurality of utterances based upon the intents corresponding to each of the plurality of utterances; and processing, by the SA computer device, each of the plurality of utterances in an order corresponding to the determined priority of each utterance.

A further enhancement of the computer-implemented method may include identifying, by the SA computer device, an entity associated with the user; assigning, by the SA computer device a role to the entity based upon the identification; and generating, by the SA computer device, the response further based upon the role assigned to the entity.

A further enhancement of the computer-implemented method may include extracting, by the SA computer device, a meaning of each of the plurality of utterances by applying the bot selected for the corresponding utterance to each of the plurality of utterances.

A further enhancement of the computer-implemented method may include determining, by the SA computer device, based upon the meaning extracted for the utterance, that the utterance corresponds to a question; determining, by the SA computer device, based upon the meaning, a requested data point that is being requested in the question; retrieving, by the SA computer device, the requested data point; and generating, by the SA computer device, the response to include the requested data point.

A further enhancement of the computer-implemented method may include determining, by the SA computer device, based upon the meaning extracted from the utterance, that the utterance corresponds to a provided data point that is being provided through the utterance; determining, by the SA computer device, based upon the meaning, a data field associated with the provided data point; and storing, by the SA computer device the provided data point in the data field within a database.

A further enhancement of the computer-implemented method may include determining, by the SA computer device, based upon the meaning, that additional data is needed from the user; generating, by the SA computer device, a request to the user to request the additional data; translating, by the SA computer device, the request into speech; and transmitting, by the SA computer device, the request in speech to the user computer device.

A further enhancement of the computer-implemented method may include wherein the verbal statement is received via at least one of a phone call, a chat program, and a video chat.

In another aspect, at least one non-transitory computer-readable media having computer-executable instructions embodied thereon may be provided. When executed by a speech analysis (SA) computing device including at least one processor in communication with at least one memory device and in communication with a user computer device associated with a user, the computer-executable instructions may cause the at least one processor to: (1) receive, from the user computer device, a verbal statement of a user including a plurality of words; (2) translate the verbal statement into text; (3) detect one or more pauses in the verbal statement; (4) divide the verbal statement into a plurality of utterances based upon the one or more pauses; (5) identify, for each of the plurality of utterances, an intent using an orchestrator model; (6) select, for each of the plurality of utterances, based upon the intent corresponding to the utterance, a bot to analyze the utterance; and/or (7) generate a response by applying the bot selected for each of the plurality of utterances to the corresponding utterance. The computer-executable instructions may direct additional, less, or alternate functionality, including that discussed elsewhere herein.

An enhancement of the non-transitory computer-readable media may include computer-executable instructions that cause a processor to translate the response into speech; and transmit the response in speech to the user computer device.

A further enhancement of the non-transitory computer-readable media may include computer executable instructions that cause a processor to generate the response by determining a priority of each of the plurality of utterances based upon the intents corresponding to each of the plurality of utterances; and process each of the plurality of utterances in an order corresponding to the determined priority of each utterance.

A further enhancement of the non-transitory computer-readable media may include computer executable instructions that cause a processor to identify an entity associated with the user; assign a role to the entity based upon the identification; and generate the response further based upon the role assigned to the entity.

A further enhancement of the non-transitory computer-readable media may include computer executable instructions that cause a processor to extract a meaning of each of the plurality of utterances by applying the bot selected for the corresponding utterance to each of the plurality of utterances.

A further enhancement of the non-transitory computer-readable media may include computer executable instructions that cause a processor to determine, based upon the meaning extracted for the utterance, that the utterance corresponds to a question; determine, based upon the meaning, a requested data point that is being requested in the question; retrieve the requested data point; and generate the response to include the requested data point.

A further enhancement of the non-transitory computer-readable media may include computer executable instructions that cause a processor to determine, based upon the meaning extracted from the utterance, that the utterance corresponds to a provided data point that is being provided through the utterance; determine, based upon the meaning, a data field associated with the provided data point; and store the provided data point in the data field within a database.

A further enhancement of the non-transitory computer-readable media may include computer executable instructions that cause a processor to determine, based upon the meaning, that additional data is needed from the user; generate a request to the user to request the additional data; translate the request into speech; and transmit the request in speech to the user computer device.

A further enhancement of the non-transitory computer-readable media may include computer executable instructions wherein the verbal statement is received via at least one of a phone call, a chat program, and a video chat.

In a further aspect, a computer system may be provided. The system may include a multimodal server including at least one processor in communication with at least one memory device. The multimodal service may be further in communication with a user computer device associated with a user. The system may also include an audio handler including at least one processor in communication with at least one memory device. The audio handler may be further in communication with the multimodal server. The at least one processor of the audio handler may be programmed to: (1) receive, from the user computer device via the multimodal server, a verbal statement of a user including a plurality of words; (2) translate the verbal statement into text; (3) select a bot to analyze the verbal statement; (4) generate an audio response by applying the bot selected for the verbal statement; and/or (5) transmit the audio response to the multimodal server. The at least one processor of the multimodal server is programmed to: (1) receive the audio response to the user from the audio handler; (2) enhance the audio response to the user; and/or (3) provide the enhanced response to the user via the user computer device. The computer system may include additional, less, or alternate functionality, including that discussed elsewhere herein.

For instance, a further enhancement of the system may include where the enhanced response includes audio and visual components. The visual component may be a text version of the audio response. The text version of the audio response may be received from the audio handler.

A further enhancement of the system may include where the enhanced response includes a display of one or more selectable items based upon the audio response. The system may also include enhanced response includes an editable field that the user is able to edit via the user computer device.

A further enhancement of the system may include at least one processor of the multimodal server that is further programmed to (1) store a database including a plurality of enhancements to a plurality of responses, and/or (2) enhance the audio response based upon the stored plurality of enhancements.

A further enhancement of the system may include at least one processor of the audio handler that is further programmed to (1) translate the audio response into speech, and/or (2) transmit the audio response in speech to the user computer device.

A further enhancement of the system may include at least one processor of the audio handler that is further programmed to (1) detect one or more pauses in the verbal statement; (2) divide the verbal statement into a plurality of utterances based upon the one or more pauses; (3) identify, for each of the plurality of utterances, an intent using an orchestrator model; (4) select, for each of the plurality of utterances, based upon the intent corresponding to the utterance, a bot to analyze the utterance; and/or (5) generate the audio response by applying the bot selected for each of the plurality of utterances to the corresponding utterance.

A further enhancement of the system may include at least one processor of the audio handler that is further programmed to (1) generate the audio response by determining a priority of each of the plurality of utterances based upon the intents corresponding to each of the plurality of utterances, and/or (2) process each of the plurality of utterances in an order corresponding to the determined priority of each utterance.

A further enhancement of the system may include at least one processor of the audio handler that is further programmed to extract a meaning of each of the plurality of utterances by applying the bot selected for the corresponding utterance to each of the plurality of utterances.

A further enhancement of the system may include at least one processor of the audio handler that is further programmed to (1) determine, based upon the meaning extracted for the utterance, that the utterance corresponds to a question; (2) determine, based upon the meaning, a requested data point that is being requested in the question; (3) retrieve the requested data point; and/or (4) generate the audio response to include the requested data point.

A further enhancement of the system may include at least one processor of the audio handler that is further programmed to (1) determine, based upon the meaning extracted from the utterance, that the utterance corresponds to a provided data point that is being provided through the utterance; (2) determine, based upon the meaning, a data field associated with the provided data point; and/or (3) store the provided data point in the data field within a database.

A further enhancement of the system may include at least one processor of the audio handler that is further programmed to (1) determine, based upon the meaning, that additional data is needed from the user; (2) generate a request to the user to request the additional data; (3) translate the request into speech; and/or (4) transmit the request in speech to the user computer device.

A further enhancement of the system may include at least one processor of the audio handler that is further programmed to (1) log a plurality of actions taken; (2) analyze a log of the plurality of actions taken for each conversation; (3) detect one or more issues based upon the analysis; and/or (4) report the one or more issues.

In a further aspect, a computer-implemented method may be provided. The computer-implemented method may be performed by a speech analysis (SA) computer device including at least one processor in communication with at least one memory device. The SA computer device in communication with a user computer device associated with a user. The method may include (1) receiving, from the user computer device, a verbal statement of a user including a plurality of words; (2) translating the verbal statement into text; (3) selecting a bot to analyze the verbal statement; (4) generating an audio response by applying the bot selected for the verbal statement; (5) enhancing the audio response to the user; and/or (6) providing the enhanced response to the user via the user computer device. The method may include additional, less, or alternate functionality, including that discussed elsewhere herein.

For instance, a further enhancement of the method may include where the enhanced response includes audio and visual components, wherein the visual component is a text version of the audio response.

A further enhancement of the method may include where the enhanced response includes a display of one or more selectable items based upon the audio response.

A further enhancement of the method may include where the enhanced response includes an editable field that the user is able to edit via the user computer device.

A further enhancement of the method may include (1) detecting one or more pauses in the verbal statement; (2) dividing the verbal statement into a plurality of utterances based upon the one or more pauses; (3) identifying, for each of the plurality of utterances, an intent using an orchestrator model; (4) selecting, for each of the plurality of utterances, based upon the intent corresponding to the utterance, a bot to analyze the utterance; and/or (5) generating the audio response by applying the bot selected for each of the plurality of utterances to the corresponding utterance.

In another aspect, at least one non-transitory computer-readable media having computer-executable instructions embodied thereon may be provided. When executed by a computing device including at least one processor in communication with at least one memory device and in communication with a user computer device associated with a user, the computer-executable instructions may cause the at least one processor to: (1) receive, from a user computer device, a verbal statement of a user including a plurality of words; (2) translate the verbal statement into text; (3) select a bot to analyze the verbal statement; (4) generate an audio response by applying the bot selected for the verbal statement; (5) enhance the audio response to the user; and/or (6) provide the enhanced response to the user via the user computer device. The instructions may direct additional, less, or alternate functionality, including that discussed elsewhere herein.

In one aspect, a multi-mode conversational computer system for implementing multiple simultaneous, nearly simultaneous or semi-simultaneous conversations and/or exchanges of information or receipt of user input may be provided. The multiple conversations may be occurring at the same time as the user switches between modes of data input, such as switching between entering user input via voice, text or typing or clicking, or touch. Additionally or alternatively, the user may enter or otherwise provide input via different input modes at the same time or nearly the same time, such as speaking while typing, clicking, and/or touching. The system may include one or more local or more processors, transceivers, servers, sensors, input devices (e.g., mouse, one or more touch screens, one or more voice bots), voice or chat bots, memory units, mobile devices, smart watches, wearables, smart glasses, augmented reality glasses, virtual reality headsets, and one or more other electronic or electric devices or components, which may be wired or wireless communication with one another. In one instance, the system may include (1) a touch display screen having a graphical user interface configured to accept user touch input; and/or (2) a voice bot configured to accept user voice input. The user may engage in multiple (e.g., two or more) separate exchanges of information/data with the computer system simultaneously, nearly simultaneously, or nearly at the same time via the touch display screen and the voice bot. The system may include additional, less, or alternate functionality, including that discussed elsewhere herein.

For instance, both the user touch input and the user voice input relate to and/or are associated with insurance. Additionally or alternatively, both the user touch input and the user voice input relate to and/or are associated with the same subject, matter, or topic (such as completing a grocery delivery, or ordering other goods or services).

In certain embodiments, both the user touch input and the user voice input relate to and/or are associated with the same insurance claim or insurance quote; the same insurance policy; handling or processing an insurance claim; generating or filling out an insurance claim; parametric insurance and/or parametric insurance claim (parametric insurance related to and/or associated with collecting and analyzing data, monitoring the data (such as sensor data), and when a threshold or trigger event is detected from analysis of the data, generating an automatic or other payout under or pursuant to an insurance claim).

In some embodiments, the computer system may be further configured to accept user selectable input via a mouse or other input device, such as a pointer.

In another aspect, a computer-implemented method of facilitating a multi-mode conversation via a computer system and/or for implementing multiple simultaneous, nearly simultaneous or semi-simultaneous conversations and/or exchanges of information or receipt of user input via the computer system may be provided. The method may include the user entering or providing input via different input modes at the same time or nearly the same time, such as speaking while typing, clicking, and/or touching. The method may be implemented via one or more local or more processors, transceivers, servers, sensors, input devices (e.g., mouse, one or more touch screens, one or more voice bots), voice or chat bots, memory units, mobile devices, smart watches, wearables, smart glasses, augmented reality glasses, virtual reality headsets, mixed or extended reality glasses or headsets, and one or more other electronic or electric devices or components, which may be wired or wireless communication with one another. In one instance, the method may include via one or more local or remote processors and/or transceivers, and one or more local or remote memory units: (1) accepting user touch input via a touch display screen having a graphical user interface configured to accept the user touch input; and/or (2) accepting user voice input via a voice bot configured to accept the user voice input. The user may engage in two or more separate exchanges of information/data related to, or associated with, the same subject matter (such as a purchase of goods or services) with the computer system simultaneously, nearly simultaneously, or nearly at the same time via the touch display screen and the voice bot. The method may include additional, less, or alternate functionality or actions, including those discussed elsewhere herein.

In another aspect, a multi-mode conversational computer system for implementing multiple (e.g., two, three, or more) simultaneous, nearly simultaneous or semi-simultaneous conversations and/or exchanges of information or receipt of user input may be provided. In one embodiment, the system may include (1) one or more processors and/or transceivers, and one or more memory units; (2) a touch display screen having a graphical user interface configured to accept user touch input (such as via the user touching the touch display screen); (3) the touch display screen and/or graphical user interface further configured to accept user selected or selectable input (such as via a mouse); and/or (4) a voice bot configured to accept user voice input. The user may engage in multiple (e.g., two, three, or more) separate exchanges of information/data related to, or associated with, the same subject matter (such as a purchase of goods or services) with the computer system simultaneously, nearly simultaneously, or nearly at the same time via the touch display screen (using user touch input (via touching the touch display screen) and/or user selected or selectable input (via the mouse or other input device)), and the voice bot. The system may include additional, less, or alternate functionality, including that discussed elsewhere herein.

In another aspect, a computer-implemented method of facilitating a multi-mode conversation via a computer system and/or for implementing multiple simultaneous, nearly simultaneous or semi-simultaneous conversations and/or exchanges of information or receipt of user input via the computer system may be provided. In one embodiment, the method may include, via one or more local or remote processors and/or transceivers, and one or more local or remote memory units: (1) accepting user touch input via a touch display screen having a graphical user interface configured to accept the user touch input; (2) accepting user selected or selectable input via a mouse and the graphical user interface or other display configured to accept the user selected or selectable input; and/or (3) accepting user voice input via a voice bot configured to accept the user voice input. The user may engage in multiple (e.g., two, three, or more) separate exchanges of information/data related to, or associated with, the same subject matter (such as a purchase of goods or services) with the computer system simultaneously, nearly simultaneously, or nearly at the same time via the touch display screen and the voice bot. The method may include additional, less, or alternate functionality or actions, including those discussed elsewhere herein.

In another aspect, a computer-implemented method of facilitating a multi-mode conversation via a computer system and/or for implementing multiple (e.g., two, three, or more) simultaneous, nearly simultaneous or semi-simultaneous conversations and/or exchanges of information or receipt of user input via the computer system may be provided. In one instance, the method may include, via one or more local or remote processors and/or transceivers, and one or more local or remote memory units: (1) accepting user selected or selectable input via a mouse and the graphical user interface or other display configured to accept the user selected or selectable input; and/or (2) accepting user voice input via a voice bot configured to accept the user voice input. The user may engage in multiple (e.g., two or more) separate exchanges of information/data related to, or associated with, the same subject matter (such as a purchase of goods or services) with the computer system simultaneously, nearly simultaneously, or nearly at the same time via the graphical user interface or display screen and the voice bot. The method may include additional, less, or alternate functionality or actions, including those discussed elsewhere herein.

In another aspect, a multi-mode conversational computer system for implementing multiple simultaneous, nearly simultaneous or semi-simultaneous conversations and/or exchanges of information or receipt of user input may be provided. In one embodiment, the system may include (i) one or more processors and/or transceivers, and one or more memory units; (ii) a touch display screen and/or graphical user interface configured to accept user selected or selectable input (such as via a mouse or other input device); and/or (iii) a voice bot configured to accept user voice input. The user may engage in multiple (e.g., two or more) separate exchanges of information/data related to, or associated with, the same subject matter (such as a purchase of goods or services) with the computer system simultaneously, nearly simultaneously, or nearly at the same time via the touch display screen (using user touch input (via touching the touch display screen) and/or user selected or selectable input (via the mouse or other input device)), and the voice bot. The system may include additional, less, or alternate functionality, including that discussed elsewhere herein.

In another aspect, a voice bot analyzer for providing voice bot quality assurance may be provided. The voice bot may have or be associated with one or more local or remote processors and/or transceivers. The voice bot analyzer may be configured to: (1) monitor and assess voice bot conversions; (2) score or grade each voice bot conversation; and/or (3) present on a display a list of the voice bot conversations along with their respective score or grade to facilitate voice bot quality assurance. The voice bot analyzer may be further configured to display a list of labels for each voice bot conversation (such as “no claim number,” “call aborted,” “lack of information,” or “no claim information.”). The voice bot analyzer may include additional, less, or alternate functionality, including that discussed elsewhere herein.

In one aspect, a computer system for analyzing voice bots may be provided. The computer system may include at least one processor and/or transceiver in communication with at least one memory device. The at least one processor and/or transceiver may be programmed to: (1) store a plurality of completed conversations, wherein each conversation of the plurality of completed conversations includes a plurality of interactions between a user and a voice bot; (2) analyze the plurality of completed conversations; (3) determine a score for each completed conversation based upon the analysis, the score indicating a quality metric for the corresponding conversation; and/or (4) generate a report based upon the plurality of scores for the plurality of completed conversations. The computer system may include additional, less, or alternate functionality, including that discussed elsewhere herein.

For instance, in a further aspect, the computer system may store the plurality of completed conversations in one or more logs within the at least one memory device. Each conversation may be associated with a unique conversation identifier. The computer system may also extract each conversation for analysis based on the corresponding unique conversation identifier.

In still a further aspect, the one or more logs may include each interaction between the user and the voice bot.

In still a further aspect, the report may include a list of labels associated with each conversation, wherein the labels include at least one of “no claim number,” “call aborted,” “lack of information,” or “no claim information.”

In still a further aspect, the computer system may identify one or more call sequence events in each conversation of the plurality of completed conversations. The call sequence events for each conversation may represent predefined events that occurred during the corresponding conversation.

In still a further aspect, the computer system may classify each completed conversation based upon the analysis of the corresponding conversation. The analysis of the corresponding conversation may include determining which actions were taken by the voice bot in response to one or more actions of the user.

In still a further aspect, the computer system may aggregate the plurality of analyzed conversations to detect one or more errors in the plurality of analyzed conversations. The one or more errors may include whether the voice bot correctly interpreted the purpose of the incoming call, correctly directed the call to the proper location, provided the proper response and/or resolved the caller's issue or request.

In still a further aspect, the computer system may report the one or more detected errors. The computer system may transmit information about the one or more detected errors to a computer device associated with an information technology professional.

In still a further aspect, the computer system may analyze a plurality of conversations completed within a first period of time. Additionally or alternatively, the computer system may analyze each conversation within a first period of time after the conversation has completed.

In still a further aspect, the computer system may determine a reason for the conversation. The computer system may determine if the reason for the conversation was completed during the conversation.

In an additional aspect, a computer-implemented method for analyzing voice bots may be provided. The method may be performed by a computer device including at least one processor and/or transceiver in communication with at least one memory device. The method may include (1) storing a plurality of completed conversations, wherein each conversation of the plurality of completed conversations includes a plurality of interactions between a user and a voice bot; (2) analyzing the plurality of completed conversations; (3) determining a score for each completed conversation based upon the analysis the score indicating a quality metric for the corresponding conversation; and/or (4) generating a report based upon the plurality of scores for the plurality of completed conversations. The method may include additional, less, or alternate functionality, including that discussed elsewhere herein.

For instance, in an additional aspect, the method may include storing the plurality of completed conversations in one or more logs within the at least one memory device, wherein each conversation is associated with a unique conversation identifier. The method may include extracting each conversation for analysis based on a corresponding unique conversation identifier.

In an additional aspect, the one or more logs include each interaction between the user and the voice bot.

In an additional aspect, the report may include a list of labels associated with each conversation, wherein the labels include at least one of “no claim number,” “call aborted,” “lack of information,” or “no claim information.”

In an additional aspect, the method may include identifying one or more call sequence events in each conversation of the plurality of completed conversations, wherein the call sequence events represent significant events that occurred during the corresponding conversation.

In an additional aspect, the method may include classifying each completed conversation based upon the analysis of the corresponding conversation, wherein the analysis of the corresponding conversation includes determining which actions were taken by the voice bot in response to one or more actions of the user.

In an additional aspect, the method may include aggregating the plurality of analyzed conversations to detect one or more errors in the plurality of analyzed conversations, wherein the one or more errors include whether the voice bot correctly interpreted the purpose of the incoming call, correctly directed the call to the proper location, provided the proper response and/or resolved the caller's issue or request.

In an additional aspect, the method may include transmitting information about the one or more detected errors to a computer device associated with an information technology professional.

In an additional aspect, the method may include analyzing a plurality of conversations completed within a first period of time.

In an additional aspect, the method may include analyzing each conversation within a first period of time after the conversation has completed.

In an additional aspect, the method may include determining a reason for the conversation. The method may include determining if the reason for the conversation was completed during the conversation.

In a further aspect, at least one non-transitory computer-readable media having computer-executable instructions embodied thereon may be provided. When executed by a computing device that may include at least one processor and/or transceiver in communication with at least one memory device and in communication with a user computer device associated with a user. The computer-executable instructions may cause the at least one processor and/or transceiver to: (1) store a plurality of completed conversations, wherein each conversation of the plurality of completed conversations includes a plurality of interactions between a user and a voice bot; (2) analyze the plurality of completed conversations; (3) determine a score for each completed conversation based upon the analysis, the score indicating a quality metric for the corresponding conversation; and/or (4) generate a report based upon the plurality of scores for the plurality of completed conversations. The instructions may direct additional, less, or alternate functionality, including that discussed elsewhere herein.

In one aspect, a multi-mode conversational computer system for implementing multiple simultaneous, nearly simultaneous, or semi-simultaneous conversations and/or exchanges of information or receipt of user input may be provided. The computer system may include: (1) at least one processor and/or transceiver in communication with at least one memory device; (2) a voice bot configured to accept user voice input and provide voice output; and/or (3) at least one input and output communication channel configured to accept user input and provide output to the user, wherein the at least one input and output communication channel is configured to communicate with the user via a first channel of the at least one input and output communication channel and the voice bot simultaneously, nearly simultaneously, or nearly at the same time. The computer system may include additional, less, or alternate functionality, including that discussed elsewhere herein.

For instance, in a further aspect, the computer system may engage the user in separate exchanges of information with the computer system simultaneously, nearly simultaneously, or nearly at the same time via the at least one input and output communication channel and the voice bot.

In still a further aspect, the first channel may include a touch display screen having a graphical user interface configured to accept user touch input.

In still a further aspect, the first channel may include a display screen having a graphical user interface. The computer system may accept user selectable input via a mouse or other input device and the display screen.

In still a further aspect, the computer system may receive the user input from one or more of the at least one input and output communication channel and the voice bot. The computer system may transmit the user input to at least one audio handler. The computer system may receive a response from the at least one audio handler. The computer system may provide the response via the at least one input and output communication channel and the voice bot.

In still a further aspect, the computer system may also generate a first response and a second response based upon the response. The first response and the second response may be different. The computer system may also provide the first response to the user via the at least one input and output channel. The computer system may also provide the second response to the user via the voice bot.

In still a further aspect, the computer system may receive the user input via the voice bot. The computer system may provide the response via the at least one input and output channel.

In still a further aspect, the computer system may also provide the response via the voice bot and the at least one input and output channel simultaneously.

In still a further aspect, the user input and the output may relate to and/or may be associated with insurance.

In an additional aspect, a computer-implemented method for facilitating a multi-mode conversation via a computer system and/or for implementing multiple simultaneous, nearly simultaneous or semi-simultaneous conversations and/or exchanges of information or receipt of user input via the computer system may be provided. The method may be performed by one or more local or remote processors and/or transceivers, which may be in communication with one or more local or remote memory units and may be in communication with at least one input and output channel and a voice bot. The method may include (1) accepting a first user input via the at least one input and output channel; and/or (2) accepting a second user input via the voice bot, wherein the first user input and the second user input are provided via the at least one input and output channel and the voice bot simultaneously, nearly simultaneously, or nearly at the same time. The method may include additional, less, or alternate functionality, including that discussed elsewhere herein.

For instance, in an additional aspect, the method may include engaging the user in separate exchanges of information simultaneously, nearly simultaneously, or nearly at the same time via the at least one input and output communication channel and the voice bot.

In an additional aspect, the method may include providing a first output via the at least one input and output channel simultaneously, nearly simultaneously, or nearly at the same time to accepting the second user input via the voice bot.

In an additional aspect, the method may include providing a first output via the at least one input and output channel simultaneously, nearly simultaneously, or nearly at the same time to providing a second output via the voice bot.

In an additional aspect, the at least one input and output channel may include a touch display screen and may have a graphical user interface configured to accept user touch input.

In an additional aspect, the at least one input and output channel may include a display screen having a graphical user interface. The method include accepting user selectable input via a mouse or other input device.

In an additional aspect, the method may include receiving user input from one or more of the at least one input and output channel and the voice bot. The method may also include transmitting the user input to at least one audio handler. The method may further include receiving a response from the at least one audio handler. In addition, the method may include providing the response via one or more of the at least one input and output channel and the voice bot.

In an additional aspect, the method may include generating a first response and a second response based upon the response. The first response and the second response may be different. The method may also include providing the first response to the user via the at least one input and output channel. The method may include providing the second response to the user via the voice bot.

In an additional aspect, the method may include receiving the user input via the voice bot. The method may include providing the response via the at least one input and output channel.

In an additional aspect, the method may include providing the response via the voice bot and the at least one input and output channel simultaneously.

In an additional aspect, the user input and the response may relate to and/or may be associated with insurance.

In still a further aspect, a computer-implemented method for facilitating a multi-mode conversation via a computer system and/or for implementing multiple simultaneous, nearly simultaneous or semi-simultaneous conversations and/or exchanges of information or receipt of user input via the computer system may be provided. The method may be performed by one or more local or remote processors and/or transceivers, which may be in communication with one or more local or remote memory units and may be in communication with at least one input and output channel and a voice bot. The method may include (1) accepting a user input via at least one of the at least one input and output channel and the voice bot; and/or (2) providing an output to the user via at least one of the at least one input and output channel and the voice bot, wherein the user input and the output to the user are provided via at least one of the at least one input and output channel and the voice bot simultaneously, nearly simultaneously, or nearly at the same time. The method may include additional, less, or alternate functionality, including that discussed elsewhere herein.

### ADDITIONAL CONSIDERATIONS

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps”, or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

In one embodiment, a computer program is provided, and the program is embodied on a computer readable medium. In an example embodiment, the system is executed on a single computer system, without requiring a connection to a sever computer. In a further embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

As used herein, an element or step recited in the singular and preceded by the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

The patent claims at the end of this document are not intended to be construed under 35 U.S.C. § 112(f) unless traditional means-plus-function language is expressly recited, such as “means for” or “step for” language being expressly recited in the claim(s).

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

We claim:

1. A multi-mode conversational computer system for implementing multiple simultaneous, nearly simultaneous or semi-simultaneous conversations and/or exchanges of information or receipt of user input, the system comprising:
one or more processors and/or transceivers, and one or more memory units;
a touch display screen having a graphical user interface configured to accept user touch input; and/or
a voice bot configured to accept user voice input,
wherein a user engages in at least two separate exchanges of information/data with the computer system simultaneously, nearly simultaneously, or nearly at the same time via the touch display screen and the voice bot.

2. The computer system of claim 1, wherein both the user touch input and the user voice input relate to and/or are associated with insurance.

3. The computer system of claim 1, wherein both the user touch input and the user voice input relate to and/or are associated with the same subject, matter, or topic including completing a grocery delivery or ordering other goods or services.

4. The computer system of claim 1, wherein both the user touch input and the user voice input relate to and/or are associated with the same insurance claim or insurance quote.

5. The computer system of claim 1, wherein both the user touch input and the user voice input relate to and/or are associated with the same insurance policy.

6. The computer system of claim 1, wherein both the user touch input and the user voice input relate to and/or are associated with handling an insurance claim.

7. The computer system of claim 1, wherein both the user touch input and the user voice input relate to and/or are associated with generating or filling out an insurance claim.

8. The computer system of claim 1, wherein both the user touch input and the user voice input relate to and/or are associated with parametric insurance and/or parametric insurance claim.

9. The computer system of claim 8, wherein parametric insurance is related to and/or associated with collecting and analyzing data, monitoring the data, and when a threshold or trigger event is detected from analysis of the data, generating an automatic or other payout under or pursuant to an insurance claim.

10. The computer system of claim 1, the computer system further configured to accept user selectable input via a mouse or other input device.

11. A computer-implemented method of facilitating a multi-mode conversation via a computer system and/or for implementing multiple simultaneous, nearly simultaneous or semi-simultaneous conversations and/or exchanges of information or receipt of user input via the computer system, the method comprising, via one or more local or remote processors and/or transceivers, and one or more local or remote memory units:
accepting user touch input via a touch display screen having a graphical user interface configured to accept the user touch input; and/or
accepting user voice input via a voice bot configured to accept the user voice input,
wherein the user engages in two or more separate exchanges of information/data with the computer system simultaneously, nearly simultaneously, or nearly at the same time via the touch display screen and the voice bot.

12. The computer-implemented method of claim 11, the method further comprising accepting user selected input via a mouse and the graphical user interface or other display configured to accept the user selected input.

13. The computer-implemented method of claim 11, wherein both the user touch input and the user voice input relate to and/or are associated with insurance.

14. The computer-implemented method of claim 11, wherein both the user touch input and the user voice input relate to and/or are associated with the same subject, matter, or topic (such as completing a grocery delivery, or ordering other goods or services).

15. A multi-mode conversational computer system for implementing multiple simultaneous, nearly simultaneous or semi-simultaneous conversations and/or exchanges of information or receipt of user input, the system comprising:
one or more processors and/or transceivers, and one or more memory units;
a touch display screen having a graphical user interface configured to accept user touch input;
the touch display screen and/or graphical user interface further configured to accept user selected or selectable input; and/or
a voice bot configured to accept user voice input,
wherein the user engages in at least two separate exchanges of information/data with the computer system simultaneously, nearly simultaneously, or nearly at the same time via the touch display screen and the voice bot.

16. The computer system of claim 15, wherein the user touch input, the user selected or selectable input, and the user voice input relate to and/or are associated with insurance.

17. The computer system of claim 15, wherein the user touch input, the user selected or selectable input, and the user voice input relate to and/or are associated with the same subject, matter, or topic.

18. The computer system of claim 17, wherein the subject, matter, or topic includes one of completing a grocery delivery or ordering or purchasing other goods or services.

19. The computer system of claim 15, wherein the at least two separate exchanges of information data include user touch input on a display via touching the touch display screen, a user selected or selectable input via a mouse or other input device, and the voice bot.
